(19) United States
(12) Patent Application Publication
(10) Pub. No.: US 2026/0062782 A1
(43) Pub. Date: Mar. 5, 2026

(54) STEEL SHEET AND METHOD OF MANUFACTURING THE SAME

(71) Applicant: NIPPON STEEL CORPORATION, Tokyo (JP)

(72) Inventors: Yuya SUZUKI, Tokyo (JP); Masayoshi SAWADA, Tokyo (JP); Masafumi AZUMA, Tokyo (JP); Kengo TAKEDA, Tokyo (JP)

(73) Assignee: NIPPON STEEL CORPORATION, Tokyo (JP)

(21) Appl. No.: 19/107,433

(22) PCT Filed: Sep. 8, 2023
(86) PCT No.: PCT/JP2023/032868

§ 371 Date: Feb. 27, 2025

(30) Foreign Application Priority Data
Sep. 9, 2022 (JP) 2022-143631

(51) Int. Cl. C22C 38/58; B32B 15/01; C21D 1/18; C21D 6/00; C21D 8/02; C21D 9/46; C22C 38/00; C22C 38/02; C22C 38/04; C22C 38/06; C22C 38/08; C22C 38/12; C22C 38/14; C22C 38/16; C22C 38/20; C22C 38/22; C22C 38/24; C22C 38/26; C22C 38/28; C22C 38/30; C22C 38/32; C22C 38/38; C22C 38/42; C22C 38/44; C22C 38/46; C22C 38/48; C22C 38/50; C22C 38/52; C22C 38/54; C22C 38/60; C23C 2/02; C23C 2/06; C23C 2/28; C23C 2/40

(52) U.S. Cl. CPC C22C 38/58; B32B 15/013; C21D 1/18; C21D 6/001; C21D 6/002; C21D 6/004; C21D 6/005; C21D 6/007; C21D 6/008; C21D 8/02; C21D 8/0226; C21D 8/0236; C21D 8/0263; C21D 8/0278; C21D 9/46; C22C 38/001; C22C 38/002; C22C 38/005; C22C 38/008; C22C 38/02; C22C 38/04; C22C 38/06; C22C 38/08; C22C 38/12; C22C 38/14; C22C 38/16; C22C 38/20; C22C 38/22; C22C 38/24; C22C 38/26; C22C 38/28; C22C 38/30; C22C 38/32; C22C 38/38; C22C 38/42; C22C 38/44; C22C 38/46; C22C 38/48; C22C 38/50; C22C 38/52; C22C 38/54; C22C 38/60; C23C 2/0224; C23C 2/06; C23C 2/285; C23C 2/40; C21D 2211/001; C21D 2211/002; C21D 2211/005; C21D 2211/008

(57) ABSTRACT

This steel sheet includes: a base steel sheet having a predetermined chemical composition; and a zinc-plated layer formed on a surface of the base steel sheet, in which, when a sheet thickness of the base steel sheet is denoted by t, a metallographic structure at a t/4 position, which is a position at t/4 from the surface in a cross section in a sheet thickness direction of the base steel sheet, contains, by volume percentage, tempered martensite: 85% or more, residual austenite: 7% or more, and one or more selected from ferrite, pearlite, bainite, and fresh martensite: 0% or more and 8% or less, a metallographic structure in a surface layer region, which is a range from the surface to a position of 50 μm in the cross section in the sheet thickness direction, contains, by volume percentage, 30% or more of bainite, and a remainder including one or more selected from ferrite, pearlite, tempered martensite, fresh martensite, and residual austenite, in the surface layer region, a diameter of prior austenite grains in the sheet thickness direction is 10.0 μm or less, and a tensile strength of the steel sheet is 1,470 MPa or more.

### TECHNICAL FIELD

The present invention relates to a steel sheet and a method of manufacturing the same.

Priority is claimed on Japanese Patent Application No. 2022-143631, filed Sep. 9, 2022, the content of which is incorporated herein by reference.

### BACKGROUND ART

Recently, as industrial technology fields are highly divided, materials used in each technology field require special and advanced performance. In particular, with regard to steel sheets for a vehicle, in order to reduce a weight of a vehicle body and improve fuel efficiency in consideration of the global environment, there is a significantly increasing demand for cold rolled high tensile strength steel sheets having a small sheet thickness and high formability. Among the steel sheets for a vehicle, particularly for cold-rolled steel sheets used for vehicle body frame components, high strength is required, and furthermore, high formability for wide applications is required. Examples of properties required for a steel sheet for a vehicle include a tensile strength (TS) of 1,470 MPa or more and excellent bendability.

Furthermore, in recent years, in order to sufficiently secure corrosion resistance of a vehicle body and components, high strength hot-dip galvanized steel sheets and high strength hot-dip galvannealed steel sheets in which a galvanized layer is provided on a surface of a steel sheet have also been applied.

For example, Patent Document 1 discloses a hot-dip galvanized steel sheet and a hot-dip galvannealed steel sheet having 980 MPa or more and being excellent in plating properties, workability in terms of a balance between strength and ductility, bendability, and hole expansibility, and delayed fracture resistance, and a method of manufacturing the same.

However, there are problems in high strength hot-dip galvanized steel sheets and high strength hot-dip galvannealed steel sheet for vehicle components. That is, resistance spot welding is mainly used in processes such as assembly of a vehicle body and attachment of components. The resistance spot welding is a type of resistance welding in which overlapping base metals are clamped between tips of electrodes of which the tips are appropriately shaped, and a current and a weld force are concentrated on a relatively small portion to locally heat the portion. However, when galvanized steel sheets (hot-dip galvanized steel sheets, electrogalvanized steel sheets, or hot-dip galvannealed steel sheets) are resistance spot-welded for the assembly of the vehicle body and/or the components, cracking called liquid metal embrittlement (LME) cracking may occur in the spot-welded portion. LME cracking is cracking that occurs when zinc in a galvanized layer melts due to heat generated during resistance spot welding, molten zinc infiltrates into grain boundaries of a steel sheet structure in a welded portion, and tensile stress acts on the state. Requirements for the occurrence of cracking are the contact between molten zinc and solid steel sleets during welding and the presence of a tensile stress (strain) acting on the site. Susceptibility to LME cracking tends to increase with high-strengthening of the steel sheet.

In Patent Document 1, a steel sheet having a tensile strength of 1,470 MPa or more is not disclosed, and a measure against LME cracking is not examined.

Regarding the above problems, a technology has been proposed to improve LME resistance during spot welding of a galvanized steel sheet.

For example, Patent Document 2 discloses a steel sheet in which, in a cross-sectional structure cut in a width direction perpendicular to a rolling direction, a block diameter in a first depth region of 1 to 10 m from a surface, a block diameter in a second depth region of 10 to 60 m from the surface, and a block diameter in a third depth region of 60 μm to a ¼ sheet thickness from the surface are each specified. Patent Document 2 shows that by forming a three-layer structure in which the block diameters are gradient-controlled from a sheet thickness surface layer toward a sheet thickness center layer, a soft layer (second layer) with a large block diameter bears strain in a case of being subjected to deformation even during spot welding, and an excessive increase in strain in an outermost layer (first layer) can be suppressed, so that the occurrence of spot weld LME cracking can be suppressed.

In Patent Document 2, it is considered that an effect of improving LME resistance to a certain degree can be obtained with regard to LME cracking (sometimes referred to as high-temperature LME cracking) that occurs at a position heated to a high temperature, such as contact surfaces of overlapping steel sheets. However, as a result of examination by the present inventors, it was found that, with the diversification of spot welding conditions in recent years, not only high-temperature LME cracking, for which measures have been examined in the related art, LME cracking (sometimes referred to as low-temperature LME cracking) may occur in a shoulder portion of an outermost surface of the steel sheet that is in contact with an energizing electrode, even though the shoulder portion is heated only to a temperature of an Al point or lower. It was found that as measures against low-temperature LME cracking, more extensive measures are required compared to measures against high-temperature LME cracking. In Patent Document 2, no measures against such low-temperature LME cracking are examined.

### CITATION LIST

### Patent Document

Patent Document 1: PCT International Publication No. WO2016/111275
Patent Document 2: PCT International Publication No. WO2021/251276

### SUMMARY OF INVENTION

### Technical Problem

As described above, in the related art, steel sheets having a strength as high as 1,470 MPa or more and being excellent in bendability and low-temperature LME resistance have not been disclosed.

Therefore, an object of the present invention is to provide a steel sheet having a strength as high as 1,470 MPa or more and being excellent in bendability and low-temperature LME resistance, and a method of manufacturing the same.

### Solution to Problem

The present inventors have examined a method for increasing strength, bendability, and low-temperature LME resistance. As a result, it was found that it is effective to control a chemical composition and then control a metallographic structure at a t/4 position, which is, when a sheet thickness of a base steel sheet is denoted by t, a position at t/4 from a surface of the base steel sheet, and a metallographic structure in a surface layer region, which is a range from the surface to a position of 50 μm.

The present invention has been made based on the above findings. The gist of the present invention is as follows. [1]A steel sheet according to an aspect of the present invention includes: a base steel sheet; and a zinc-plated layer formed on a surface of the base steel sheet, in which the base steel sheet has a chemical composition including, by mass %, C: 0.180% or more and 0.400% or less, Si: 0.050% or more and 1.000% or less, Mn: 2.00% or more and 4.00% or less, Al: 0.10% or more and 2.00% or less, Ti: 0.010% or more and 0.200% or less, B: 0.0010% or more and 0.0100% or less, N: 0.0010% or more and 0.0100% or less, P: 0% or more and 0.0400% or less, S: 0% or more and 0.0100% or less, O: 0% or more and 0.0060% or less, Cr: 0% or more and 0.50% or less, Ni: 0% or more and 1.00% or less, Cu: 0% or more and 1.00% or less, Mo: 0% or more and 0.500% or less, Nb: 0% or more and 0.200% or less, V: 0% or more and 0.500% or less, W: 0% or more and 0.100% or less, Ta: 0% or more and 0.100% or less, Sn: 0% or more and 0.050% or less, Co: 0% or more and 0.500% or less, As: 0% or more and 0.050% or less, Sb: 0% or more and 0.050% or less, Mg: 0% or more and 0.050% or less, Ca: 0% or more and 0.040% or less, REM: 0% or more and 0.050% or less, Zr: 0% or more and 0.050% or less, Bi: 0% or more and 0.050% or less, Sr: 0% or more and 0.050% or less, and a remainder: Fe and impurities, when a sheet thickness of the base steel sheet is denoted by t, a metallographic structure at a t/4 position, which is a position at t/4 from the surface in a cross section in a sheet thickness direction of the base steel sheet, contains, by volume percentage, tempered martensite: 85% or more, residual austenite: 7% or more, and one or more selected from ferrite, pearlite, bainite, and fresh martensite: 0% or more and 8% or less, a metallographic structure in a surface layer region, which is a range from the surface to a position of 50 m in the cross section in the sheet thickness direction, contains, by volume percentage, 30% or more of bainite, and a remainder including one or more selected from ferrite, pearlite, tempered martensite, fresh martensite, and residual austenite, in the surface layer region, a diameter of prior austenite grains in the sheet thickness direction is 10.0 μm or less, and a tensile strength of the steel sheet is 1,470 MPa or more.

[2] In the steel sheet according to [1], when an Al content is denoted by <<Al>>, a N content is denoted by <<N>>, and a Ti content is denoted by <<Ti>> in terms of atomic %, Expression (1) is satisfied,

$$〈 〈 Al 〉 〉 \geq 〈 〈 N 〉 〉 - 0.5 \times 〈 〈 Ti 〉 〉 . \qquad ( 1 )$$

[3] In the steel sheet according to [1] or [2], the zinc-plated layer may be a hot-dip galvanized layer.

[4] In the steel sheet according to [1] or [2], the zinc-plated layer may be a hot-dip galvannealed layer.

[5]A method of manufacturing a steel sheet according to another aspect of the present invention, includes: a heating process of heating a slab such that a heating temperature T in units of K satisfies Expression (2) when an Al content is denoted by [Al] and a N content is denoted by [N] in terms of mass %; a hot rolling process of hot-rolling the slab after the heating process to obtain a steel sheet; a coiling process of cooling the steel sheet to a coiling temperature of 500° C. or lower at an average cooling rate of 20° C./sec or faster and coiling the steel sheet at the coiling temperature; a cold rolling process of cold-rolling the steel sheet at a cumulative rolling reduction of 20% or less after pickling the steel sheet after the coiling process as necessary; an annealing process of heating the steel sheet to an annealing temperature of an Ac3 point or higher and 900° C. or lower in an atmosphere having an oxygen potential of −1.50 or more and holding the steel sheet at the annealing temperature for 10 seconds or longer and 600 seconds or shorter; a first cooling process of cooling the steel sheet after the annealing process to a first temperature range of an Ms point −100° C. or higher and a Bs point or lower at an average cooling rate of 20° C./sec or faster; a holding process of holding the steel sheet in the first temperature range for 60 seconds or longer and 600 seconds or shorter; and a second cooling process of cooling the steel sheet after the holding process to a second temperature range of 250° C. or lower and 150° C. or higher at an average cooling rate of 20° C./sec or faster,

$${log}_{10} ( [ Al ] \times [ N ] ) \leq - 9730 / T + 3.36 . \qquad ( 2 )$$

### Advantageous Effects of Invention

According to the above aspect of the present invention, it is possible to provide a steel sheet having a strength as high as 1,470 MPa or more and excellent in bendability and low-temperature LME resistance and a method of manufacturing the same.

### DESCRIPTION OF EMBODIMENTS

A steel sheet according to an embodiment of the present invention (a steel sheet according to the present embodiment) includes: a base steel sheet having a predetermined chemical composition; and a zinc-plated layer formed on a surface of the base steel sheet, in which a predetermined metallographic structure is present at a t/4 position, which is a position at t/4 from a surface in a cross section in a sheet thickness direction, and in a surface layer region, which is a range from the surface to a position of 50 m in the cross section in the sheet thickness direction, a diameter of prior austenite grains in the sheet thickness direction in the surface layer region is 10.0 μm or less, and a tensile strength is 1,470 MPa or more.

Hereinafter, each will be described.

### [Base Steel Sheet]

### <Chemical Composition>

The chemical composition of the base steel sheet of the steel sheet according to the present embodiment will be described. “%” regarding an amount of each element indicates “mass %” unless otherwise specified.

C: 0.180% or More and 0.400% or Less

C (carbon) is an essential element for securing strength of the steel sheet. By setting a C content to 0.180% or more, desired high strength can be obtained. The C content is preferably 0.200% or more, and more preferably 0.220% or more. On the other hand, in order to secure workability and weldability, the C content is set to 0.400% or less. The C content is preferably 0.380% or less, and more preferably 0.360% or less.

Si: 0.050% or More and 1.000% or Less

Si (silicon) is an effective element for suppressing the generation of iron carbide in austenite having an increased C concentration and obtaining stable residual austenite even at room temperature. In order to obtain this effect, a Si content is set to 0.050% or more.

On the other hand, in order to secure the weldability of the steel sheet, the Si content is set to 1.000% or less. The Si content is preferably 0.900% or less and more preferably 0.800% or less.

Mn: 2.00% or More and 4.00% or Less

Mn (manganese) is a strong austenite stabilizing element, and is an effective element for high-strengthening of the steel sheet. In order to obtain this effect, a Mn content is set to 2.00% or more. The Mn content is preferably 2.20% or more, and more preferably 2.40% or more.

On the other hand, a high Mn content leads to a decrease in the weldability and low temperature toughness. Therefore, the Mn content is set to 4.00% or less. The Mn content is preferably 3.60% or less, and more preferably 3.20% or less.

Al: 0.10% or More and 2.00% or Less

Al (aluminum) is an element used for deoxidation of steel, and like Si, is an effective element for suppressing the generation of iron carbide and obtaining residual austenite.

In addition, in the steel sheet according to the present embodiment, Al is an element that is precipitated as AlN and contributes to the refinement of the structure. In order to obtain the above effect, an Al content (total Al content) is set to 0.10% or more. In addition, the Al content is preferably set to a range in which Expression (1) is satisfied in a relationship with a Ti content and a N content in terms of atomic %, as described later.

On the other hand, even if Al is contained excessively, the effect is saturated, and not only does the cost rise, but also a transformation temperature of the steel rises and a load during hot rolling increases. Therefore, the Al content is set to 2.00% or less. The Al content is preferably 1.50% or less, and more preferably 1.20% or less.

Ti: 0.010% or More and 0.200% or Less

Ti (titanium) is an effective element for securing solute B that contributes to an improvement in the hardenability by fixing N to form TiN. In order to obtain this effect, the Ti content is set to 0.010% or more.

On the other hand, when the Ti content exceeds 0.200%, there is a concern that coarse carbonitrides are precipitated and formability decreases. Therefore, the Ti content is set to 0.200% or less. The Ti content is preferably 0.180% or less, and more preferably 0.160% or less.

In addition, when the Ti content is more than a predetermined proportion with respect to the Al content, the precipitation of AlN is inhibited by the excessive precipitation of TiN. Therefore, as described later, the Ti content is preferably set to a range in which Expression (1) is satisfied in relation to the Al content and the N content in terms of atomic %.

B: 0.0010% or More and 0.0100% or Less

B (boron) is an element that segregates at austenite grain boundaries during welding, thereby strengthening the grain boundaries, and contributing to an improvement in resistance to liquid metal embrittlement cracking. In addition, B is an element that increases the hardenability of steel and contributes to the high-strengthening of the steel sheet.

In order to obtain the above effect, a B content is set to 0.0010% or more. The B content is preferably 0.0015% or more, and more preferably 0.0020% or more.

On the other hand, when the B content exceeds 0.0100%, carbides and nitrides are generated, the above-described effects are saturated, and hot workability decreases. Therefore, the B content is set to 0.0100% or less. The B content is preferably 0.0080% or less, more preferably 0.0050% or less, and even more preferably 0.0030% or less.

N: 0.0010% or More and 0.0100% or Less

N (nitrogen) is an element that is bonded to Al to precipitate as AlN and contributes to the refinement of the structure. In order to obtain this effect, the N content is set to 0.0010% or more. The N content is preferably 0.0020% or more. On the other hand, when the N content exceeds 0.0100%, coarse nitrides are formed in steel, and bendability and the hole expansibility deteriorate. Therefore, the N content is set to 0.0100% or less. The N content is preferably 0.0080% or less, and more preferably 0.0060% or less.

P: 0% or More and 0.0400% or Less

P (phosphorus) is a solid solution strengthening element, and is an effective element for high-strengthening of the steel sheet, but excessive inclusion thereof deteriorates the weldability and toughness. Therefore, a P content is set to 0.0400% or less. The P content is preferably 0.0350% or less, 0.0300% or less, or 0.0200% or less. The P content may be 0%, but extremely reducing the P content increases a dephosphorization cost. Therefore, the P content may be set to 0.0010% or more from the viewpoint of economic efficiency.

S: 0% or More and 0.0100% or Less

S (sulfur) is an element contained as an impurity, and is an element which forms MnS in steel and deteriorates the toughness and hole expansibility. Therefore, a S content is set to 0.0100% or less as a range in which the deterioration of the toughness and hole expansibility is not significant. The S content is preferably 0.0050% or less, 0.0040% or less, or 0.0030% or less. The S content may be 0%, but extremely reducing the S content increases a desulfurization cost. Therefore, the S content may be set to 0.0001% or more, or 0.0010% or more from the viewpoint of economic efficiency.

O: 0% or More and 0.0060% or Less

O (oxygen) is an element contained as an impurity, and is an element which forms coarse oxides in steel and deteriorates the bendability and hole expansibility when an O content exceeds 0.0060%. Therefore, the O content is set to 0.0060% or less. The O content is preferably 0.0050% or less, and more preferably 0.0040% or less. The O content may be 0%, but the O content may be set to 0.0001% or more from the viewpoint of manufacturing cost.

The steel sheet according to the present embodiment contains, as a basic chemical composition, the above-described elements (basic elements) and the remainder including Fe and impurities. Here, the “impurities” mean components that are mixed due to various factors in raw materials such as ore and scrap, and in the manufacturing process when the steel sheet is industrially manufactured, and are permitted within a range that does not adversely affect the present invention.

However, the steel sheet may contain the following elements (optional elements) instead of a portion of Fe, as necessary. Since these elements do not necessarily have to be contained, lower limits thereof are 0%. In addition, the following elements may be mixed from scrap or the like in the raw materials, but may be intentionally contained in the steel sheet or may be unintentionally contained in the steel sheet in amounts equal to or less than the upper limits described below. For example, there are cases where the following elements are contained in the steel sheet by being contained in scrap or the like in the raw materials of the steel sheet.
Cr: 0% or More and 0.50% or Less
Ni: 0% or More and 1.00% or Less
Cu: 0% or More and 1.00% or Less

Cr (chromium), Ni (nickel), and Cu (copper) are all elements that contribute to the improvement in strength. Therefore, one or more selected from these elements may be contained as necessary. In a case where the above effect is to be obtained, amounts of one or more selected from Cr, Ni, and Cu are preferably 0.01% or more, and more preferably 0.10% or more.

On the other hand, there is a concern that a Cr content exceeding 0.50%, a Ni content exceeding 1.00%, or a Cu content exceeding 1.00% causes a decrease in pickling properties, weldability, and hot workability. Therefore, the Cr content is set to 0.50% or less, the Ni content is set to 1.00% or less, and the Cu content is set to 1.00% or less. The Cr content may be 0.40% or less, 0.30% or less, or 0.10% or less. The Ni content may be 0.80% or less, 0.60% or less, or 0.20% or less. The Cu content may be 0.80% or less, 0.60% or less, or 0.20% or less.

Mo: 0% or More and 0.500% or Less

Mo (molybdenum) is, like Mn, an element that increases the hardenability of steel and contributes to the improvement in strength. Therefore, Mo may be contained as necessary. In a case where the above effect is to be obtained, a Mo content is preferably 0.010% or more, and more preferably 0.100% or more.

On the other hand, when the Mo content exceeds 0.500%, the hot workability decreases, and there is a concern that productivity decreases. Therefore, the Mo content is set to 0.500% or less. The Mo content is preferably 0.400% or less, more preferably 0.300% or less, and even more preferably 0.100% or less.
Nb: 0% or More and 0.200% or Less
V: 0% or More and 0.500% or Less

Both Nb (niobium) and V (vanadium) are elements that contribute to the improvement in the strength of the steel sheet by precipitation hardening, grain refinement strengthening by suppressing crystal grain growth, and dislocation strengthening by suppressing recrystallization. Therefore, one or more selected from these elements may be contained as necessary. In a case where the above effect is to be obtained, it is preferable that one or two of 0.001% or more of Nb and 0.001% or more of V are contained in the steel sheet.

On the other hand, there is a concern that a Nb content exceeding 0.200% or a V content exceeding 0.500% causes the precipitation of coarse carbonitrides and a decrease in the formability. Therefore, the Nb content is set to 0.200% or less, and the V content is set to 0.500% or less.

The Nb content is preferably 0.180% or less, more preferably 0.150% or less, and even more preferably 0.100% or less. The V content is preferably 0.400% or less, more preferably 0.300% or less, and even more preferably 0.100% or less.
W: 0% or More and 0.100% or Less
Ta: 0% or More and 0.100% or Less
Sn: 0% or More and 0.050% or Less
Co: 0% or More and 0.500% or Less
As: 0% or More and 0.050% or Less

W (tungsten), Ta (tantalum), Sn (tin), Co (cobalt), and As (arsenic) are elements that contribute to the improvement in the strength of the steel sheet by precipitation hardening and suppression the coarsening of crystal grains. Therefore, these elements may be contained. In a case where the effect is to be obtained, it is preferable to contain one or two or more of these elements, and set a W content to 0.001% or more, a Ta content to 0.001% or more, a Sn content to 0.001% or more, a Co content to 0.001% or more, and an As content to 0.001% or more.

On the other hand, when these elements are contained in a large amount, there is a concern that various properties of the steel sheet are impaired. Therefore, the W content is set to 0.100% or less, the Ta content is set to 0.100% or less, the Sn content is set to 0.050% or less, the Co content is set to 0.500 or less, and the As content is set to 0.050% or less. The W content is preferably 0.080% or less, more preferably 0.050% or less, and even more preferably 0.030% or less. The Ta content is preferably 0.080% or less, more preferably 0.050% or less, and even more preferably 0.030% or less. The Sn content is preferably 0.040% or less, more preferably 0.030% or less, and even more preferably 0.010% or less. The Co content is preferably 0.400% or less, more preferably 0.300% or less, and even more preferably 0.100% or less. The As content is preferably 0.040% or less, more preferably 0.030% or less, and even more preferably 0.010% or less.
Sb: 0% or More and 0.050% or Less
Mg: 0% or More and 0.050% or Less
Ca: 0% or More and 0.040% or Less
REM: 0% or More and 0.050% or Less
Zr: 0% or More and 0.050% or Less
Bi: 0% or More and 0.050% or Less
Sr: 0% or More and 0.050% or Less

Sb (antimony), Mg (magnesium), Ca (calcium), REM (rare earth metal), Zr (zirconium), Bi (bismuth), and Sr (strontium) are all elements that contribute to the improvement in formability. Therefore, one or more selected from these elements may be contained as necessary. In a case where the above effect is to be obtained, it is preferable to contain one or two or more selected from Sb, Mg, Ca, REM, Zr, Bi, and Sr and set the amount of each contained element to 0.001% or more. The amount of each element is more preferably 0.002% or more.

On the other hand, there is a concern that a Sb, Mg, REM, Zr, Bi, or Sr content exceeding 0.050% or a Ca content exceeding 0.040% causes the decrease in the pickling properties, weldability, and hot workability. Therefore, the Sb, Mg, REM, Zr, Bi, and Sr contents are all set to 0.050% or less, and the Ca content is set to 0.040% or less. Each of the Sb, Mg, Ca, REM, Zr, Bi, and Sr contents is preferably 0.035% or less, 0.030% or less, or 0.010% or less.

In the present embodiment, REM means rare earth elements and is a generic term for a total of 17 elements including Sc, Y, and lanthanoids, and the REM content is a total amount of these elements.

As described above, the base steel sheet of the steel sheet according to the present embodiment contains, as a chemical composition, basic elements and the remainder including Fe and impurities, or contains basic elements and further contains one or more optional elements and the remainder including Fe and impurities.

In the steel sheet according to the present embodiment, grain sizes are refined by AlN precipitated by continuous annealing. When the Al content is small compared to the N content that remains without being consumed as TiN, there are cases where AlN is not sufficiently formed. Therefore, when the Al content is denoted by <<Al>>, the N content is denoted by <<N>>, and the Ti content is denoted by <<Ti>> in terms of atomic %, it is preferable that Expression (1) is satisfied.

$$〈 〈 Al 〉 〉 \geq 〈 〈 N 〉 〉 - 0.5 \times 〈 〈 Ti 〉 〉 \qquad ( 1 )$$

The chemical composition of the base steel sheet of the steel sheet according to the present embodiment may be measured by a general method. For example, the chemical composition may be measured using inductively coupled plasma-atomic emission spectrometry (ICP-AES) for chips according to JIS G 1201: 2014. In this case, the chemical composition is an average content throughout an entire sheet thickness. For the elements which cannot be measured by ICP-AES, C and S may be measured using a combustion-infrared absorption method, N may be measured using an inert gas fusion-thermal conductivity method, and O may be measured using an inert gas fusion-non-dispersive infrared absorption method.

An analysis sample is collected so as to obtain an average chemical composition throughout the overall sheet thickness of the base steel sheet, as described in JIS G 0417:1999. Specifically, the analysis sample is collected from a ¼ thickness position in the sheet thickness direction from the surface of the base steel sheet, avoiding end portions of the base steel sheet in a width direction.

In the above method, the amount of each element is measured in terms of mass %. The amount of each element in terms of atomic % can be obtained by converting the amount of each element in terms of mass % using the following conversion expression.

$$〈 〈 Al 〉 〉 = ( [ Al ] / 27 ) / A$$

$$〈 〈 N 〉 〉 = ( [ N ] / 14 ) / A$$

$$〈 〈 Ti 〉 〉 = ( [ Ti ] / 47.9 ) / A$$

Here, [element symbol] included in the above expression indicates the amount (unit mass %) of each element included in the steel sheet, and A is a value obtained by the following expression from the amount of each element.

$$A = [ Fe ] / 55.8 + [ C ] / 12 + [ Si ] / 28.1 + [ Mn ] / 54.9 + [ Al ] / 27 + [ Ti ] / 47.9 + [ B ] / 10.8 + [ N ] / 14 + [ P ] / 31 + [ S ] / 32.1 + [ O ] / 16 + [ Cr ] / 52 + [ Ni ] / 58.7 + [ Cu ] / 63.5 + [ Mo ] / 95.9 + [ Nb ] / 92.9 + [ V ] / 50.9 + [ W ] / 183.8 + [ Ta ] / 180.9 + [ Sn ] / 118.7 + [ Co ] / 63.6 + [ As ] / 74.9 + [ Sb ] / 121.8 + [ Mg ] / 24.3 + [ Ca ] / 40.1 + [ Y ] / 88.9 + [ La ] / 138.9 + [ Ce ] / 140.1 + [ Zr ] / 91.2 + [ Bi ] / 209 + [ Sr ] / 87.6$$

### <Metallographic Structure>

In the steel sheet according to the present embodiment, the metallographic structure at the t/4 position, which is the position at t/4 from the surface (that is, in a case where a plating layer is provided, the surface excluding the plating layer of the steel sheet according to the present embodiment) of the base steel sheet in the cross section in the sheet thickness direction when a sheet thickness of the base steel sheet is denoted by t, and the metallographic structure in the surface layer region, which is a range from the surface to the position of 50 m, are limited.

Hereinafter, a fraction of each phase in the metallographic structure is a volume percentage.

### (Metallographic Structure at t/4 Position)

First, the metallographic structure at the t/4 position will be described.

Tempered Martensite: 85% or More

In the steel sheet according to the present embodiment, a volume percentage of tempered martensite is set to 85% or more to secure a tensile strength of 1,470 MPa or more. When the volume percentage of tempered martensite is less than 85%, a sufficient tensile strength cannot be secured. When the volume percentage of the tempered martensite exceeds 93%, a sufficient volume percentage of residual austenite cannot be secured. Therefore, the volume percentage of tempered martensite is 93% or less.

Fresh martensite is also effective from the viewpoint of contributing to the high-strengthening, but fresh martensite is a brittle structure and has poor formability. Therefore, the steel sheet according to the present embodiment contains tempered martensite as a main structure.

Residual Austenite: 7% or More

Residual austenite is a structure that improves elongation of a steel sheet by a TRIP effect in which residual austenite transforms into martensite due to strain-induced transformation during deformation of the steel sheet. Therefore, the volume percentage of residual austenite is set to 7% or more.

As the volume percentage of residual austenite increases, the elongation of the steel sheet increases. However, in order to obtain a large amount of residual austenite, it is necessary to include a large amount of alloying elements such as C. Therefore, the volume percentage of residual austenite is set to 15% or less.

One or More Selected from Ferrite, Pearlite, Bainite, and Fresh Martensite: 0% or More and 8% or Less

As a remainder other than tempered martensite and residual austenite, one or more selected from ferrite, pearlite, bainite, and fresh martensite may be contained. A volume percentage of the remainder is 8% or less in order to secure the predetermined volume percentages of tempered martensite and residual austenite. The volume percentage of the remainder is preferably 5% or less, and more preferably 3% or less. The volume percentage of the remainder may be 0%.

The volume percentage of each structure (each phase) at the t/4 position is obtained by the following procedure.

That is, for the volume percentages of ferrite, pearlite, bainite, fresh martensite, and tempered martensite, a test piece is collected from a certain position in a rolling direction of the steel sheet at a center position in the width direction, a longitudinal section (that is, a cross section parallel to the rolling direction and parallel to the thickness direction) parallel to the rolling direction is polished, and a metallographic structure that is revealed by nital etching at the ¼ position of the sheet thickness t from the surface in the sheet thickness direction is observed using SEM. In the SEM observation, five visual fields of 30 μm in the sheet thickness direction and 50 μm in the rolling direction are observed at a magnification of 3,000-fold so that the ¼ position of the sheet thickness t from the surface in the sheet thickness direction is at the center. An area ratio of each structure is measured from the observed image, and an average value thereof is calculated. Since there is no microstructural change in a direction (steel sheet width direction) perpendicular to the rolling direction and area ratios of the longitudinal section parallel to the rolling direction are equal to volume percentages, the area ratios obtained by the structural observation are each used as volume percentages.

In the measurement of the area ratio of each structure, a region with no substructure revealed and a low luminance is defined as ferrite. In addition, a region that is a layered structure of ferrite and cementite is defined as pearlite. In addition, a region with no substructure revealed and a high luminance is defined as fresh martensite or residual austenite. In addition, a region in which a substructure is revealed is defined as tempered martensite or bainite.

Bainite and tempered martensite can be distinguished from each other by further carefully observing intragranular carbides.

Specifically, tempered martensite includes martensite laths and cementite generated within the laths. Here, since there are two or more kinds of crystal orientation relationships between martensite laths and cementite, cementite included in the tempered martensite has a plurality of variants. On the other hand, bainite is classified into upper bainite and lower bainite. Upper bainite includes lath-shaped bainitic ferrite and cementite generated at the interface between the laths and is thus easily distinguished from tempered martensite. Lower bainite includes lath-shaped bainitic ferrite and cementite generated within the laths. Here, there is one kind of crystal orientation relationship between bainitic ferrite and cementite unlike tempered martensite, and cementite included in lower bainite has the same variant. Therefore, lower bainite and tempered martensite are distinguished from each other on the basis of the variants of cementite.

On the other hand, fresh martensite and residual austenite are not clearly distinguished from each other by the SEM observation. Therefore, a volume percentage of martensite is calculated by subtracting the volume percentage of residual austenite calculated by a method described later from a volume percentage of a structure determined to be martensite or residual austenite.

The volume percentage of residual austenite is obtained by collecting a test piece from a certain position in the rolling direction of the steel sheet at a center position in the width direction, chemically polishing a rolled surface from the surface of the steel sheet to the ¼ position of the sheet thickness, and quantifying integrated intensities of (200) and (210) planes of ferrite and (200), (220), and (311) planes of austenite by MoKα radiation.

### (Metallographic Structure in Surface Layer Region)

Next, the metallographic structure in the surface layer region will be described.

Bainite: 30 vol % or More

The bendability is improved by forming the surface layer region into a soft structure. However, when a difference between a hardness of the surface layer region and a hardness of an inside (for example, the t/4 position) of the steel sheet is too large, there are cases where strain is concentrated on the surface layer region, and the bendability decreases. Therefore, in the surface layer region, a volume percentage of bainite is set to 30% or more. The volume percentage of bainite is preferably 50% or more, and more preferably 70% or more. Bainite may occupy 100%.

Remainder: One or More Selected from Ferrite, Pearlite, Tempered Martensite, Fresh Martensite, and Residual Austenite

The remainder other than bainite includes one or more selected from ferrite, pearlite, tempered martensite, fresh martensite, and residual austenite.

Among these, ferrite contributes to an improvement in bendability and also contributes to an improvement in LME resistance. Therefore, it is preferable that ferrite and bainite are contained so that a total volume percentage thereof is 50% or more.

Diameter of Prior Austenite Grains in Sheet Thickness Direction: 10.0 μm or Less

The present inventors have examined LME cracking in the steel sheet in which the metallographic structures at the t/4 position and in the surface layer region have been controlled as described above. As a result, it have been found that a diffusion path of molten zinc, which causes LME cracking, is a prior austenite grain boundary, so that LME cracking can be suppressed by reducing the diameter of the prior austenite grains in the sheet thickness direction.

Therefore, in the steel sheet according to the present embodiment, the diameter of the prior austenite grains in the sheet thickness direction in the surface layer region is set to 10.0 μm or less. By reducing the diameter of the prior austenite grains in this manner, not only high-temperature LME cracking but also low-temperature LME cracking are suppressed. When the diameter of the prior austenite grains in the sheet thickness direction exceeds 10.0 μm, the diffusion of molten zinc is significant, and low-temperature LME cracking is likely to occur.

The diameter of the prior austenite grains in the sheet thickness direction is preferably 9.0 μm or less, and more preferably 7.0 μm or less.

The volume percentage of each structure in the metallographic structure of the surface layer region can be measured by the same method as the measurement at the t/4 position described above. However, an observation range by SEM is set to three visual fields of 30 μm in the sheet thickness direction and 50 μm in the rolling direction so that a position of 15 μm from the surface is at the center, and three visual fields of 30 μm in the sheet thickness direction and 50 μm in the rolling direction so that a position of 35 μm from the surface is at the center.

In addition, the diameter of the prior austenite grains in the sheet thickness direction is obtained by the following method.

A range including a range of 30 μm or more and 50 μm or less from the surface in the cross section in the sheet thickness direction is imaged using a crystal orientation analysis by SEM and electron backscatter diffraction (SEM-EBSD). In the obtained image, a straight line is drawn from a position of 30 μm from the surface to a position of 50 μm from the surface in the sheet thickness direction, and the number of prior austenite grains included in the straight line is counted. The diameter of the prior austenite grains in the sheet thickness direction is calculated by dividing the number of the obtained prior austenite grains by 20 μm (measurement distance). The above measurement is performed at five or more positions in a direction perpendicular to the sheet thickness direction, and the diameters of the prior austenite grains in the sheet thickness direction at each position are averaged to obtain the diameter of the prior austenite grains in the sheet thickness direction in the surface layer region.

Here, the prior austenite grains are determined by measuring crystal orientation data of B.C.C.-iron by SEM-EBSD, determining boundaries with a crystal orientation difference of 15 degrees or more as grain boundaries in the obtained crystal orientation map data of B.C.C.-iron, and determining grain boundaries of tempered martensite, fresh martensite, and bainite. At that time, among the regions surrounded by the grain boundaries, a region in which an intragranular GAM value (grain average misorientation) is larger than 0.5 degrees is determined to be tempered martensite, fresh martensite, or bainite. A measurement interval (STEP) is set to 0.01 μm or more and 0.10 m or less, and may be selected to be 0.05 μm.

### [Plating Layer]

The steel sheet according to the present embodiment includes the zinc-plated layer. Corrosion resistance is improved by providing the zinc-plated layer. When there is a concern about holes due to corrosion in a steel sheet for a vehicle, there are cases where the steel sheet cannot be thinned to a certain sheet thickness or less even if the high-strengthening is achieved. One of the purposes of the high-strengthening of the steel sheet is to reduce the weight by thinning. Therefore, even if a high strength steel sheet is developed, an application range of a steel sheet with low corrosion resistance is limited. As a method for solving these problems, a highly corrosion-resistant zinc-plated layer is formed on the surface of the steel sheet.

The zinc-plated layer may be a hot-dip galvanized layer or a hot-dip galvannealed layer that has undergone alloying. The hot-dip galvanized layer is preferable from the viewpoint of cost, and the hot-dip galvannealed layer is preferable from the viewpoint of obtaining excellent weldability and coatability since Fe is incorporated into the hot-dip galvanized layer by an alloying treatment.

In addition, upper layer plating may be performed on the zinc-plated layer for the purpose of improving the coatability and weldability. In addition, in a cold-rolled steel sheet according to the present embodiment, various treatments such as a chromate treatment, a phosphate treatment, a lubricity improvement treatment, and a weldability improvement treatment may be performed on the hot-dip galvanized layer.

### Characteristics

Tensile Strength: 1,470 MPa or More

In the steel sheet according to the present embodiment, as a strength that contributes to a weight reduction of a vehicle body of a vehicle, the tensile strength (TS) is 1,470 MPa or more.

An upper limit of the tensile strength is not limited. However, when the tensile strength is high, there is a concern that the formability decreases. Therefore, the tensile strength may be set to 1,600 MPa or less.

The tensile strength (TS) is obtained by collecting a JIS No. 5 tensile test piece from the steel sheet in a direction perpendicular to the rolling direction and performing a tensile test according to JIS Z 2241: 2011.

In addition, since the steel sheet according to the present embodiment has the chemical composition and the metallographic structure limited as described above, the steel sheet has excellent bendability and low-temperature LME resistance. As bending properties, a maximum bending angle evaluated by a bending test according to the VDA standard is preferably 90 degrees or more.

### [Sheet Thickness]

A sheet thickness of the steel sheet according to the present embodiment is not limited, but is preferably 1.0 mm or more and 3.0 mm or less from the viewpoint of achieving both the weight reduction of the vehicle body and an improvement in collision safety.

### Manufacturing Method

Next, a suitable example of a method of manufacturing a steel sheet according to the present embodiment will be described.

According to this manufacturing method, the steel sheet according to the present embodiment can be obtained. However, the manufacturing method described below does not limit the range of the steel sheet according to the present embodiment. A steel sheet satisfying the requirements described above is regarded as the steel sheet according to the present embodiment regardless of the manufacturing method thereof.

Specifically, the steel sheet according to the present embodiment is obtained by a manufacturing method including the following steps:
(I) a heating step of heating a slab such that a heating temperature T in units of K satisfies log₁₀([Al]×[N])≤−9730/T+3.36 when an Al content is denoted by [Al] and a N content is denoted by [N] in terms of mass %;
(II) a hot rolling step of hot-rolling the slab after the heating step to obtain a steel sheet;
(III) a coiling step of cooling the steel sheet to a coiling temperature of 500° C. or lower at an average cooling rate of 20° C./see or faster and coiling the steel sheet at the coiling temperature;
(IV) a cold rolling step of cold-rolling the steel sheet at a cumulative rolling reduction of 20% or less after pickling the steel sheet after the coiling step as necessary;
(V) an annealing step of heating the steel sheet to an annealing temperature of an Ac3 point or higher and 900° C. or lower in an atmosphere having an oxygen potential of −1.50 or more and holding the steel sheet at the annealing temperature for 10 seconds or longer and 600 seconds or shorter;
(VI) a first cooling step of cooling the steel sheet after the annealing step to a first temperature range of an Ms point −100° C. or higher and a Bs point or lower at an average cooling rate of 20° C./see or faster;
(VII) a holding step of holding the steel sheet in the first temperature range for 60 seconds or longer and 600 seconds or shorter; and
(VIII) a second cooling step of cooling the steel sheet after the holding step to a second temperature range of 250° C. or lower and 150° C. or higher at an average cooling rate of 20° C./see or faster.

In a case of obtaining the steel sheet according to the present embodiment, it is necessary to reduce the diameter of the prior austenite grains in the sheet thickness direction and to control the metallographic structure at the t/4 position and the metallographic structure in the surface layer region by forming the metallographic structure into an acicular structure through the hot rolling step and the coiling step and annealing the steel sheet having the acicular structure under conditions described below to increase an aspect ratio of the prior austenite grains in the steel sheet after the annealing. These are obtained by a combination of a plurality of steps. That is, not only the individual steps but also the chemical composition and the conditions of each of the steps from the heating step to the second cooling step affect the conditions of the other steps. Therefore, in each step, it is important to control the conditions while taking into consideration the conditions of the other steps and to perform overall control of the series of steps.

The Ac3 point is obtained by the following expression.

$$AC 3 ( ° C . ) = 910 - 203 \times {[ C ]}^{1 / 2} + 44.7 \times [ Si ] - 30 \times [ Mn ] + 700 \times [ P ] - 20 \times [ Cu ] - 15.2 \times [ Ni ] - 11 \times [ Cr ] + 31.15 \times [ Mo ] + 400 \times [ Ti ] + 104 \times [ V ] + 120 \times [ Al ]$$

The Ms point is a temperature at which martensite begins to be generated during cooling after start of quenching. In the manufacturing method according to the present embodiment, a value that is calculated by the following expression is regarded as the Ms point.

$$Ms ( ° C . ) = 541 - 474 \times [ C ] / ( 1 - S α / 100 ) - 15 \times [ Si ] - 35 \times [ Mn ] - 17 \times [ Cr ] - 17 \times [ Ni ] + 19 \times [ Al ]$$

The Bs point is a temperature at which bainitic transformation starts during cooling after start of quenching. In the manufacturing method according to the present embodiment, a value calculated by the following expression is regarded as the Bs point.

$$Bs ( ° C . ) = 820 - 290 \times [ C ] / ( 1 - S α ) - 37 \times [ Si ] - 90 \times [ Mn ] - 65 \times [ Cr ] - 50 \times [ Ni ] + 70 \times [ Al ]$$

Here, [element symbol] included in the calculation expressions of the Ac3 point the Ms point, and the Bs point indicates the amount (unit mass %) of each element included in the steel sheet. The symbol Su included in the expression is a ferrite fraction (unit volume %) of the steel sheet at the point in time when the heating for quenching is ended.

However, it is difficult to obtain the area ratio of ferrite in the steel sheet during manufacturing.

Therefore, a steel sheet which has undergone a temperature history similar to that of an actual steel sheet manufacturing process is prepared in advance, the area ratio of ferrite in a steel sheet center portion of the steel sheet is obtained, and the area ratio of ferrite is used for calculation of Ms and Bs. The ferrite fraction of the steel sheet largely depends on the heating temperature for quenching. Therefore, in a case where the cooling conditions are examined, manufacturing conditions for the steps before cooling are first determined, and a steel sheet is manufactured under the above manufacturing conditions. By measuring a ferrite fraction of the steel sheet, Sa can be specified.

### <Heating Step>

In the heating step, the slab is heated such that the heating temperature T in units of K satisfies Expression (2) when the Al content is denoted by [Al] and the N content is denoted by [N] in terms of mass %.

$${log}_{10} ( [ Al ] \times [ N ] ) \leq - 9730 / T + 3.36 . \qquad ( 2 )$$

In the heating step, Al and N in the slab are brought into a solid solution state. Therefore, it is necessary to heat the steel sheet to a temperature at which Expression (2) is satisfied, taking into account a solubility product of Al and N. In a case where Expression (2) is not satisfied, coarse AlN precipitated during casting remains, and fine AlN cannot be precipitated during annealing. Coarse AlN precipitated during casting hardly contributes to the refinement of the structure. An upper limit of the heating temperature in the heating step is not particularly limited, but the heating temperature is, for example, 1,350° C. or lower from the viewpoint of a capacity of heating equipment and productivity.

A method of manufacturing the slab to be subjected to the heating step is not limited. A steel piece having the above-described chemical composition may be manufactured by melting, refining, and casting. For example, the steel piece can be manufactured by continuous casting, a thin slab caster, or the like.

### <Hot Rolling Step>

In the hot rolling step, the slab after the heating step is hot-rolled to obtain a steel sheet.

In the hot rolling conditions, a finish rolling finishing temperature is set to 850° C. or higher. In the hot rolling step and the coiling step, the metallographic structure is formed into the acicular structure. However, when the finish rolling finishing temperature is lower than 850° C., ferrite and/or pearlite having a small aspect ratio are generated, and a proportion of the acicular structure (bainite or martensite) in the steel sheet decreases. An upper limit of the finish rolling finishing temperature is, for example, 1,350° C. or lower from the viewpoint of productivity or the like.

### <Coiling Step>

In the coiling step, the steel sheet after the hot rolling step is cooled to a coiling temperature of 500° C. or lower at an average cooling rate of 20° C./see or faster and is coiled at the coiling temperature. As a result, the structure of the steel sheet after the coiling step is formed into an acicular structure. By annealing the steel sheet having the acicular structure under conditions described below, it is possible to increase the aspect ratio of the prior austenite grains in the steel sheet after annealing and to reduce the diameter of the prior austenite grains in the sheet thickness direction.

When the average cooling rate up to the coiling temperature is slower than 20° C./sec or the coiling temperature exceeds 500° C., ferrite and/or pearlite having a small aspect ratio are generated, and the proportion of the acicular structure in the steel sheet decreases. The average cooling rate up to the coiling temperature is, for example, 200° C./sec or slower. The coiling temperature is, for example, 20° C. or higher from the viewpoint of productivity or the like.

### <Cold Rolling Step>

In the cold rolling step, the steel sheet after the coiling step is pickled as necessary and then cold-rolled. In a case where the steel sheet is cold-rolled, a cold rolling ratio (cumulative rolling reduction) is set to 20% or less. When the cold rolling ratio is set to more than 20%, the steel sheet after the cold rolling step contains a large amount of dislocations, and heating for annealing allows the dislocations to promote recrystallization of the structure of the steel sheet, and the proportion of the acicular structure in the steel sheet decreases, which is not preferable. Therefore, the rolling reduction is limited to 20% or less in order to prevent an excessive amount of dislocations from being introduced into the steel sheet and to increase the aspect ratio of the prior austenite grains in the steel sheet after annealing.

In the method of manufacturing a steel sheet according to the present embodiment, omission of the cold rolling, that is, setting the cold rolling ratio to 0% is also permitted. However, since the cold rolling promotes the precipitation of AlN that contributes to refinement of a prior austenite grain size, the cold rolling may be performed with a rolling reduction of 20% or less.

In a case where pickling is performed before cold rolling, the pickling may be performed by a known method.

### <Annealing Step>

In the annealing step, the steel sheet after the coiling step or the cold rolling step is heated to an annealing temperature of the Ac3 point or higher and 900° C. or lower in an atmosphere having an oxygen potential of −1.50 or more and holding the steel sheet at the annealing temperature for 10 seconds or longer and 600 seconds or shorter.

When the annealing temperature is lower than the Ac3 point or a holding time at the annealing temperature is shorter than 10 seconds, y transformation is insufficient, and a preferable final metallographic structure cannot be obtained. In addition, the precipitation of AlN for refining the metallographic structure is also insufficient.

On the other hand, when the annealing temperature exceeds 900° C., austenite grains become coarse. In addition, when the holding time at the annealing temperature exceeds 600 seconds, austenite grains become coarse and the productivity decreases.

In addition, in the annealing step, decarburization in the surface layer region is promoted, and the metallographic structure of the surface layer region in the steel sheet finally obtained is formed into a structure softer than that at the t/4 position.

When the oxygen potential of the atmosphere for heating is lower than −1.50, the decarburization of the surface layer region is insufficient. The oxygen potential of the atmosphere for heating the steel sheet is the common logarithm of a value obtained by dividing water vapor partial pressure P_{H2O} in the atmosphere by hydrogen partial pressure P_{H2}, that is, log₁₀(P_{H2O}/P_{H2}). The oxygen potential in the annealing step is, for example, −0.01 or less.

In a case where the decarburization is promoted, the metallographic structure of the surface layer region tends to become coarse. However, the metallographic structure of the surface layer region can be refined by the precipitation of AlN, and the diameter of the prior austenite grains in the sheet thickness direction can be reduced to 10.0 m or less as described above.

### <First Cooling Step>

In the first cooling step, the steel sheet after the annealing step is cooled to a first temperature range of (Ms point −100° C.) or higher and the Bs point or lower at an average cooling rate of 20° C./sec or faster.

When the average cooling rate is slower than 20° C./sec or a cooling stop temperature exceeds the Bs point, ferrite, pearlite, and the like are excessively generated during cooling or after cooling, and a desired metallographic structure cannot be obtained. The average cooling rate in the first cooling step is, for example, 200° C./sec or slower.

In addition, when the cooling stop temperature is lower than the Ms point −100° C., the holding step of the subsequent step cannot be performed. Alternatively, even in a case where the reheating and holding in the first temperature range can be performed, martensite is excessively formed when the cooling is stopped, and a predetermined amount of residual austenite cannot be finally secured.

### <Holding Step>

In the holding step, a temperature of the steel sheet is held in the first temperature range of (Ms point −100° C.) or higher and the Bs point or lower for 60 seconds or longer and 600 seconds or shorter.

This temperature range is a temperature range at which bainite is formed. Therefore, by holding the steel sheet in this temperature range, bainitic transformation is caused to occur in the surface layer region.

When the holding time is shorter than 60 seconds, a sufficient volume percentage of bainite cannot be obtained. On the other hand, when the holding time exceeds 600 seconds, bainitic transformation occurs even at the t/4 position, and the desired metallographic structure cannot be obtained.

The holding mentioned in the present embodiment may be such that the temperature of the steel sheet is in a range of (Ms point −100° C.) or higher and the Bs point or lower, and in this temperature range, a temperature change may occur.

In a case of performing plating (forming a plating layer), the steel sheet is immersed in a hot-dip galvanizing bath. In addition, a hot-dip galvanized steel sheet may be subjected to an alloying treatment to obtain a hot-dip galvannealed steel sheet. In this case, holding of the temperature of the steel sheet described above can be performed by using heat applied to the steel sheet during hot-dip galvanizing and alloying. In any case, known conditions can be applied.

### <Second Cooling Step>

In the second cooling step, the steel sheet after the holding step is cooled to a second temperature range of 250° C. or lower and 150° C. or higher at an average cooling rate of 20° C./sec or faster.

Through this cooling, untransformed austenite is transformed (some stable austenite remains as residual austenite). When the average cooling rate is slower than 20° C./sec or a cooling stop temperature exceeds 250° C., the volume percentages of phases other than tempered martensite in the metallographic structure at the t/4 position become excessive, and a desired metallographic structure cannot be obtained. The average cooling rate in the second cooling step is, for example, 200° C./sec or slower.

### EXAMPLES

Slabs having the chemical compositions shown in Tables 1-1 to 1-4 were produced by continuous casting.

The slabs were heated to the heating temperatures shown in Tables 2-1 and 2-2 and hot-rolled such that a finish rolling finishing temperature was the temperature shown in Tables 2-1 and 2-2 to obtain hot-rolled steel sheets having a thickness of 2.8 mm. However, in No. 38 and No. 42, slab cracking had occurred, and thus the subsequent tests were not performed.

The hot-rolled steel sheets after the hot rolling were cooled to the coiling temperatures at the average cooling rates shown in Tables 2-1 and 2-2, coiled at the coiling temperatures, and cooled to room temperature.

Thereafter, the coiled hot-rolled steel sheets were uncoiled, and some of the hot rolled steel sheets were cold-rolled at the cumulative rolling reductions shown in Tables 2-1 and 2-2 after pickling, thereby obtaining cold-rolled steel sheets having a thickness of 2.2 to 2.8 mm. (examples with a cumulative rolling reduction of “-” mean that cold rolling was not performed)

Thereafter, the steel sheets (cold-rolled steel sheets in a case where cold rolling was performed, and hot-rolled steel sheets after the hot rolling in a case where cold rolling was not performed) were annealed under the conditions shown in Tables 2-1 and 2-2. At that time, the holding times at the heating temperature (annealing temperature) were set to 10 seconds or longer and 600 seconds or shorter.

Thereafter, first cooling, holding, and second cooling were performed under the conditions shown in Tables 3-1 and 3-2. At that time, some of the steel sheets were immersed in a hot-dip galvanizing bath during the holding to obtain hot-dip galvanized steel sheets. In addition, some of the hot-dip galvanized steel sheets were subjected to an alloying treatment to obtain hot-dip galvannealed steel sheets. The holding time in the table is a time including a time of immersion in the hot-dip galvanizing bath and a time of being at a predetermined temperature by the alloying treatment. In addition, the cooling stop temperature in the second cooling was set to 150° C. or higher and 250° C. or lower.

The Ms point (° C.) and the Bs point (° C.) were obtained using the following expressions based on the chemical composition of the slab. At that time, for Sa, a steel sheet that had undergone the same temperature history was prepared in advance, the area ratio of ferrite in a steel sheet center portion of the steel sheet was obtained, and the obtained value was adopted.

$$Ms = 541 - 474 \times [ C ] / ( 1 - S α / 100 ) - 15 \times [ Si ] - 35 \times [ Mn ] - 17 \times [ Cr ] - 17 \times [ Ni ] + 19 \times [ Al ]$$

$$Bs = 820 - 290 \times [ C ] / ( 1 - S α ) - 37 \times [ Si ] - 90 \times [ Mn ] - 65 \times [ Cr ] - 50 \times [ Ni ] + 70 \times [ Al ]$$

The fraction (volume percentage) of each phase, and the diameter of the prior austenite grains in the sheet thickness direction in the structure at the t/4 position and the structure in the surface layer region of the base steel sheet of the obtained steel sheet (hot-rolled steel sheet, cold-rolled steel sheet, hot-dip galvanized steel sheet, and hot-dip galvannealed steel sheet) were measured by the above-described methods.

The results are shown in Tables 4-1 to 4-2.

In addition, the tensile strength (TS), bendability, and low-temperature LME resistance of the obtained steel sheet were evaluated in the following manner. The results are shown in Tables 5-1 and 5-2.

[Tensile Strength (TS)]The tensile strength (TS) was obtained by collecting a JIS No. 5 tensile test piece from the steel sheet in a direction perpendicular to the rolling direction, and performing a tensile test according to JIS Z 2241: 2011.

When the tensile strength was 1,470 MPa or more, it was determined that a desired strength was achieved.

### [Bendability]

A bending test was performed in accordance with VDA238-100 of the VDA standard, and a maximum bending angle was obtained.

In a case where the maximum bending angle was 90 degrees or more, it was determined that excellent bendability was achieved.

### [Low-Temperature LME Resistance]

Welding was continuously performed using a servo motor pressurized single-phase AC spot welding machine (current frequency 50 Hz) with a welding pressure of 400 kgf and a current value changed to 11 kA, 9 kA, or 13 kA, and a cross section passing through a center of a nugget was observed at a magnification of 50-fold using an optical microscope.

As a result of the observation, those with no cracking in a shoulder portion were determined to have excellent low-temperature LME resistance.

TABLE 1-1
Unit mass % Remainder: Fe and impurities

| No. | C | Si | Mn | Al | Ti | B | N | P | S |
|---|---|---|---|---|---|---|---|---|---|
| A | 0.365 | 0.280 | 3.01 | 0.38 | 0.013 | 0.0020 | 0.0038 | 0.0341 | 0.0011 |
| B | 0.185 | 0.622 | 2.32 | 0.25 | 0.040 | 0.0090 | 0.0050 | 0.0077 | 0.0054 |
| C | 0.245 | 0.781 | 2.19 | 0.40 | 0.018 | 0.0090 | 0.0020 | 0.0216 | 0.0010 |
| D | 0.224 | 0.135 | 3.42 | 0.60 | 0.035 | 0.0020 | 0.0011 | 0.0035 | 0.0008 |
| E | 0.265 | 0.404 | 2.91 | 0.68 | 0.023 | 0.0020 | 0.0017 | 0.0063 | 0.0006 |
| F | 0.304 | 0.514 | 2.26 | 0.54 | 0.049 | 0.0050 | 0.0011 | 0.0014 | 0.0004 |
| G | 0.337 | 0.737 | 3.54 | 0.26 | 0.035 | 0.0080 | 0.0020 | 0.0028 | 0.0077 |
| H | 0.313 | 0.067 | 2.34 | 0.95 | 0.014 | 0.0020 | 0.0013 | 0.0304 | 0.0015 |
| I | 0.372 | 0.839 | 2.76 | 0.65 | 0.019 | 0.0020 | 0.0016 | 0.0022 | 0.0086 |
| J | 0.276 | 0.602 | 2.66 | 0.21 | 0.017 | 0.0040 | 0.0020 | 0.0111 | 0.0007 |
| K | 0.203 | 0.965 | 3.24 | 0.36 | 0.030 | 0.0020 | 0.0020 | 0.0038 | 0.0005 |
| L | 0.351 | 0.208 | 3.22 | 0.32 | 0.012 | 0.0030 | 0.0020 | 0.0028 | 0.0009 |
| M | 0.287 | 0.319 | 3.13 | 1.30 | 0.022 | 0.0020 | 0.0013 | 0.0017 | 0.0012 |
| N | 0.205 | 0.440 | 2.12 | 0.29 | 0.037 | 0.0070 | 0.0030 | 0.0039 | 0.0030 |
| O | 0.245 | 0.788 | 2.43 | 0.31 | 0.021 | 0.0090 | 0.0032 | 0.0014 | 0.0007 |
| P | 0.273 | 0.792 | 2.88 | 0.25 | 0.035 | 0.0020 | 0.0020 | 0.0040 | 0.0007 |
| Q | 0.308 | 0.055 | 3.88 | 1.38 | 0.038 | 0.0090 | 0.0012 | 0.0048 | 0.0004 |
| R | 0.387 | 0.065 | 3.81 | 1.37 | 0.035 | 0.0020 | 0.0015 | 0.0031 | 0.0078 |
| S | 0.285 | 0.085 | 2.53 | 0.25 | 0.026 | 0.0080 | 0.0020 | 0.0041 | 0.0010 |
| T | 0.243 | 0.622 | 2.12 | 0.51 | 0.019 | 0.0090 | 0.0020 | 0.0024 | 0.0005 |
| U | 0.214 | 0.688 | 3.24 | 0.35 | 0.015 | 0.0020 | 0.0020 | 0.0334 | 0.0006 |
| V | 0.328 | 0.443 | 3.95 | 0.39 | 0.015 | 0.0020 | 0.0014 | 0.0028 | 0.0019 |

| No. | O | Cr | Ni | Cu | Mo | Nb | V | W | Ta | Sn |
|---|---|---|---|---|---|---|---|---|---|---|
| A | 0.0003 | — | — | — | — | — | — | — | — | — |
| B | 0.0010 | — | — | — | — | — | — | — | — | — |
| C | 0.0003 | — | — | — | — | — | — | — | — | — |
| D | 0.0004 | — | — | — | — | — | — | — | — | — |
| E | 0.0017 | — | — | — | — | — | — | — | — | — |
| F | 0.0007 | — | — | — | — | — | — | — | — | — |
| G | 0.0008 | — | — | — | — | — | — | — | — | — |
| H | 0.0033 | — | — | — | — | — | — | — | — | — |
| I | 0.0004 | — | — | — | — | — | — | — | — | — |
| J | 0.0050 | — | — | — | — | — | — | — | — | — |
| K | 0.0044 | — | — | — | — | — | — | — | — | — |
| L | 0.0007 | — | — | — | — | — | — | — | — | — |
| M | 0.0005 | — | — | — | — | — | — | — | — | — |
| N | 0.0005 | — | — | — | — | — | — | — | — | — |
| O | 0.0004 | — | — | — | — | — | — | — | — | — |
| P | 0.0032 | 0.28 | — | — | 0.032 | — | — | — | — | — |
| Q | 0.0005 | — | 0.26 | 0.11 | — | — | — | 0.009 | — | — |
| R | 0.0005 | 0.03 | — | 0.05 | 0.033 | 0.017 | — | — | — | — |
| S | 0.0046 | 0.08 | — | — | 0.126 | 0.013 | — | 0.004 | — | — |
| T | 0.0010 | — | — | — | — | 0.019 | 0.055 | — | — | — |
| U | 0.0004 | 0.04 | — | — | 0.029 | — | — | — | — | — |
| V | 0.0018 | — | 0.13 | 0.05 | — | — | — | 0.004 | — | — |

TABLE 1-2
Unit mass % Remainder: Fe and impurities

| No. | C | Si | Mn | Al | Ti | B | N | P | S |
|---|---|---|---|---|---|---|---|---|---|
| W | 0.320 | 0.292 | 3.19 | 0.74 | 0.019 | 0.0030 | 0.0016 | 0.0046 | 0.0012 |
| X | 0.347 | 0.856 | 3.62 | 0.69 | 0.029 | 0.0070 | 0.0021 | 0.0202 | 0.0006 |
| Y | 0.379 | 0.883 | 3.75 | 0.27 | 0.015 | 0.0020 | 0.0036 | 0.0063 | 0.0051 |
| Z | 0.389 | 0.314 | 3.17 | 0.35 | 0.019 | 0.0030 | 0.0037 | 0.0306 | 0.0086 |
| AA | 0.362 | 0.082 | 3.64 | 1.53 | 0.017 | 0.0050 | 0.0011 | 0.0013 | 0.0011 |
| AB | 0.265 | 0.130 | 3.57 | 0.37 | 0.016 | 0.0040 | 0.0033 | 0.0041 | 0.0009 |
| AC | 0.228 | 0.542 | 2.77 | 0.26 | 0.049 | 0.0020 | 0.0020 | 0.0032 | 0.0005 |
| AD | 0.183 | 0.591 | 3.36 | 0.34 | 0.035 | 0.0080 | 0.0028 | 0.0038 | 0.0028 |
| AE | 0.173 | 0.439 | 3.76 | 0.27 | 0.035 | 0.0020 | 0.0032 | 0.0035 | 0.0025 |
| AF | 0.406 | 0.164 | 2.51 | 0.26 | 0.023 | 0.0090 | 0.0020 | 0.0318 | 0.0012 |
| AG | 0.191 | 0.026 | 3.86 | 0.33 | 0.013 | 0.0060 | 0.0032 | 0.0313 | 0.0083 |
| AH | 0.312 | 1.020 | 3.53 | 0.27 | 0.036 | 0.0030 | 0.0015 | 0.0016 | 0.0006 |
| AI | 0.372 | 0.131 | 1.94 | 0.24 | 0.019 | 0.0040 | 0.0036 | 0.0051 | 0.0011 |
| AJ | 0.186 | 0.242 | 4.05 | 0.82 | 0.017 | 0.0020 | 0.0017 | 0.0049 | 0.0075 |
| AK | 0.292 | 0.242 | 2.98 | 0.05 | 0.015 | 0.0030 | 0.0020 | 0.0023 | 0.0081 |
| AL | 0.339 | 0.575 | 2.74 | 2.04 | 0.017 | 0.0080 | 0.0014 | 0.0124 | 0.0007 |
| AM | 0.376 | 0.928 | 3.22 | 0.42 | 0.006 | 0.0030 | 0.0020 | 0.0035 | 0.0015 |
| AN | 0.376 | 0.137 | 2.11 | 0.31 | 0.206 | 0.0040 | 0.0040 | 0.0074 | 0.0013 |
| AO | 0.280 | 0.305 | 2.45 | 0.56 | 0.031 | 0.0005 | 0.0013 | 0.0274 | 0.0027 |
| AP | 0.368 | 0.246 | 2.65 | 0.30 | 0.028 | 0.0150 | 0.0032 | 0.0042 | 0.0021 |
| AQ | 0.397 | 0.633 | 3.71 | 0.61 | 0.025 | 0.0090 | 0.0006 | 0.0034 | 0.0076 |
| AR | 0.393 | 0.757 | 2.05 | 0.35 | 0.056 | 0.0090 | 0.0180 | 0.0038 | 0.0078 |

| No. | O | Cr | Ni | Cu | Mo | Nb | V | W | Ta | Sn |
|---|---|---|---|---|---|---|---|---|---|---|
| W | 0.0049 | 0.03 | — | 0.07 | 0.054 | 0.036 | — | — | — | — |
| X | 0.0005 | 0.08 | — | — | 0.059 | 0.017 | — | 0.018 | — | — |
| Y | 0.0004 | 0.43 | — | — | — | 0.060 | 0.092 | — | — | — |
| Z | 0.0006 | 0.04 | — | — | 0.048 | — | — | — | 0.007 | — |
| AA | 0.0006 | — | 0.07 | 0.29 | — | — | — | 0.007 | 0.006 | 0.008 |
| AB | 0.0007 | 0.38 | — | 0.07 | 0.278 | 0.026 | — | — | 0.007 | — |
| AC | 0.0006 | 0.13 | — | — | 0.421 | 0.029 | — | 0.005 | — | 0.004 |
| AD | 0.0006 | — | — | — | — | 0.033 | 0.041 | — | 0.009 | — |
| AE | 0.0011 | — | — | — | 0.237 | — | 0.259 | — | — | — |
| AF | 0.0004 | — | 0.49 | 0.50 | 0.236 | 0.100 | 0.238 | — | 0.052 | 0.026 |
| AG | 0.0010 | 0.25 | 0.48 | 0.51 | — | 0.102 | 0.255 | 0.053 | 0.049 | 0.025 |
| AH | 0.0007 | — | — | 0.50 | 0.258 | — | 0.252 | — | 0.050 | — |
| AI | 0.0002 | — | — | 0.51 | — | — | — | — | 0.052 | — |
| AJ | 0.0006 | 0.26 | 0.50 | 0.47 | 0.265 | — | 0.247 | 0.052 | — | — |
| AK | 0.0005 | — | — | — | — | 0.104 | 0.246 | — | 0.052 | — |
| AL | 0.0013 | 0.24 | 0.48 | — | 0.260 | 0.103 | — | 0.051 | 0.048 | 0.024 |
| AM | 0.0012 | 0.25 | 0.49 | — | — | 0.105 | — | 0.047 | 0.047 | — |
| AN | 0.0006 | 0.26 | — | — | — | 0.102 | — | 0.050 | 0.053 | 0.024 |
| AO | 0.0006 | 0.25 | 0.53 | 0.52 | 0.240 | 0.101 | — | — | 0.051 | 0.025 |
| AP | 0.0007 | 0.26 | 0.53 | 0.52 | 0.249 | — | 0.248 | — | — | — |
| AQ | 0.0050 | 0.24 | 0.51 | 0.48 | 0.258 | 0.105 | 0.244 | — | — | — |
| AR | 0.0004 | — | — | — | 0.238 | — | 0.251 | — | — | — |

TABLE 1-3

| | | | | | | | | | | | | | Remark | | | | | |
|---|---|---|---|---|---|---|---|---|---|---|---|---|---|---|---|---|---|---|
| | | | | | | | | | | | | | | | | | | Establish- |
| Unit mass % Remainder: Fe and impurities | | | | | | | | | | | | | | | | | | ment of |
| | | | | | | | | | REM | | | | Ac3 | log₁₀ | <<Al>> | <<N>> | <<Ti>> | Expres- |
| No. | Co | As | Sb | Mg | Ca | Y | La | Ce | (total) | Zr | Bi | Sr | (° C.) | ([Al] × [N]) | [at %] | [at %] | [at %] | sion (1) |
| A | — | — | — | — | — | — | — | — | — | — | — | — | 784 | −2.84 | 0.770 | 0.0148 | 0.0148 | Established |
| B | — | — | — | — | — | — | — | — | — | — | — | — | 832 | −2.90 | 0.509 | 0.0196 | 0.0453 | Established |
| C | — | — | — | — | — | — | — | — | — | — | — | — | 849 | −3.10 | 0.810 | 0.0078 | 0.0200 | Established |
| D | — | — | — | — | — | — | — | — | — | — | — | — | 806 | −3.18 | 1.221 | 0.0043 | 0.0401 | Established |
| E | — | — | — | — | — | — | — | — | — | — | — | — | 831 | −2.94 | 1.377 | 0.0066 | 0.0257 | Established |
| F | — | — | — | — | — | — | — | — | — | — | — | — | 839 | −3.23 | 1.092 | 0.0043 | 0.0559 | Established |
| G | — | — | — | — | — | — | — | — | — | — | — | — | 766 | −3.28 | 0.525 | 0.0078 | 0.0393 | Established |
| H | — | — | — | — | — | — | — | — | — | — | — | — | 870 | −2.91 | 1.921 | 0.0051 | 0.0154 | Established |
| I | — | — | — | — | — | — | — | — | — | — | — | — | 828 | −2.98 | 1.306 | 0.0062 | 0.0215 | Established |
| J | — | — | — | — | — | — | — | — | — | — | — | — | 790 | −3.38 | 0.426 | 0.0078 | 0.0189 | Established |
| K | — | — | — | — | — | — | — | — | — | — | — | — | 822 | −3.14 | 0.729 | 0.0078 | 0.0342 | Established |
| L | — | — | — | — | — | — | — | — | — | — | — | — | 748 | −3.19 | 0.650 | 0.0078 | 0.0137 | Established |
| M | — | — | — | — | — | — | — | — | — | — | — | — | 887 | −2.77 | 2.615 | 0.0050 | 0.0244 | Established |
| N | — | — | — | — | — | — | — | — | — | — | — | — | 826 | −3.06 | 0.591 | 0.0118 | 0.0425 | Established |
| O | — | — | — | — | — | — | — | — | — | — | — | — | 818 | −3.00 | 0.628 | 0.0125 | 0.0234 | Established |
| P | — | — | — | — | — | — | — | — | — | — | — | — | 798 | −3.30 | 0.506 | 0.0078 | 0.0400 | Established |
| Q | — | — | — | — | — | — | — | — | — | — | — | — | 861 | −2.78 | 2.778 | 0.0047 | 0.0426 | Established |
| R | — | — | — | — | — | — | — | — | — | — | — | — | 853 | −2.69 | 2.751 | 0.0058 | 0.0396 | Established |
| S | — | — | — | — | — | — | — | — | — | — | — | — | 776 | −3.30 | 0.510 | 0.0079 | 0.0293 | Established |
| T | — | — | — | — | — | — | — | — | — | — | — | — | 850 | −2.99 | 1.033 | 0.0078 | 0.0217 | Established |
| U | — | — | — | — | — | — | — | — | — | — | — | — | 821 | −3.15 | 0.710 | 0.0078 | 0.0166 | Established |
| V | — | — | — | — | — | — | — | — | — | — | — | — | 747 | −3.26 | 0.790 | 0.0055 | 0.0166 | Established |

TABLE 1-4

| Unit mass % Remainder: Fe and impurities | | | | | | | | | | | | | Remark |
|---|---|---|---|---|---|---|---|---|---|---|---|---|---|
| | | | | | | | | | REM | | | | Ac3 |
| No. | Co | As | Sb | Mg | Ca | Y | La | Ce | (total) | Zr | Bi | Sr | (° C.) |
| W | — | — | — | — | — | — | — | — | — | — | — | — | 812 |
| X | — | — | — | — | — | — | — | — | — | — | — | — | 830 |
| Y | — | — | — | — | — | — | — | — | — | — | — | — | 760 |
| Z | — | — | 0.003 | — | — | — | — | — | — | — | — | — | 774 |
| AA | — | 0.005 | — | — | — | — | — | — | — | — | — | — | 867 |
| AB | — | 0.010 | 0.014 | 0.005 | — | — | — | 0.005 | 0.005 | 0.036 | — | — | 761 |
| AC | 0.068 | — | — | — | 0.012 | 0.003 | 0.036 | — | 0.039 | — | — | 0.004 | 819 |
| AD | — | — | 0.004 | 0.028 | — | — | 0.005 | — | 0.005 | 0.003 | 0.038 | — | 811 |
| AE | 0.254 | — | — | — | — | 0.026 | — | 0.024 | 0.050 | — | — | — | 815 |
| AF | 0.249 | — | 0.025 | 0.024 | 0.021 | 0.026 | — | — | 0.026 | 0.006 | 0.025 | 0.004 | 790 |
| AG | — | 0.024 | 0.026 | — | 0.020 | — | — | — | — | — | — | — | 779 |
| AH | 0.258 | 0.024 | — | 0.025 | 0.021 | 0.024 | — | — | 0.024 | — | 0.026 | 0.015 | 808 |
| AI | 0.251 | 0.026 | 0.024 | 0.026 | — | 0.026 | 0.024 | — | 0.050 | 0.026 | 0.024 | 0.014 | 763 |
| AJ | — | 0.024 | — | 0.026 | — | — | — | 0.026 | 0.026 | 0.015 | — | 0.004 | 835 |
| AK | — | 0.024 | — | — | — | 0.006 | 0.012 | 0.013 | 0.031 | 0.013 | — | — | 754 |
| AL | — | 0.025 | 0.026 | 0.026 | — | 0.026 | 0.024 | — | 0.050 | — | — | 0.004 | 994 |
| AM | — | — | 0.026 | — | — | — | — | — | — | 0.008 | 0.025 | 0.010 | 775 |
| AN | — | — | 0.024 | 0.024 | 0.020 | — | — | — | — | — | — | 0.008 | 850 |
| AO | — | — | — | 0.024 | 0.019 | — | — | — | — | 0.005 | — | — | 828 |
| AP | 0.255 | — | 0.024 | — | — | — | 0.025 | — | 0.025 | 0.004 | — | — | 781 |
| AQ | 0.252 | 0.026 | — | 0.025 | 0.021 | — | — | 0.024 | 0.024 | — | — | — | 798 |
| AR | — | — | — | 0.025 | — | — | 0.025 | 0.013 | 0.038 | — | — | 0.006 | 856 |

| | Remark | | | | |
|---|---|---|---|---|---|
| Unit mass % | | | | | Establish- |
| Remainder: Fe | | | | | ment of |
| and impurities | log₁₀ | <<Al>> | <<N>> | <<Ti>> | Expres- |
| No. | ([Al] × [N]) | [at %] | [at %] | [at %] | sion (1) |
| W | −2.93 | 1.496 | 0.0062 | 0.0217 | Established |
| X | −2.84 | 1.387 | 0.0081 | 0.0328 | Established |
| Y | −3.01 | 0.544 | 0.0140 | 0.0170 | Established |
| Z | −2.89 | 0.708 | 0.0144 | 0.0211 | Established |
| AA | −2.77 | 3.070 | 0.0043 | 0.0192 | Established |
| AB | −2.91 | 0.754 | 0.0130 | 0.0178 | Established |
| AC | −3.28 | 0.530 | 0.0079 | 0.0557 | Established |
| AD | −3.02 | 0.691 | 0.0110 | 0.0401 | Established |
| AE | −3.06 | 0.551 | 0.0126 | 0.0397 | Established |
| AF | −3.28 | 0.529 | 0.0078 | 0.0264 | Established |
| AG | −2.98 | 0.676 | 0.0126 | 0.0144 | Established |
| AH | −3.39 | 0.546 | 0.0058 | 0.0405 | Established |
| AI | −3.06 | 0.488 | 0.0141 | 0.0212 | Established |
| AJ | −2.86 | 1.668 | 0.0067 | 0.0195 | Established |
| AK | −4.00 | 0.102 | 0.0079 | 0.0167 | Established |
| AL | −2.54 | 4.064 | 0.0054 | 0.0191 | Established |
| AM | −3.08 | 0.846 | 0.0078 | 0.0068 | Established |
| AN | −2.91 | 0.629 | 0.0157 | 0.2358 | Established |
| AO | −3.14 | 1.138 | 0.0051 | 0.0355 | Established |
| AP | −3.02 | 0.609 | 0.0125 | 0.0321 | Established |
| AQ | −3.44 | 1.229 | 0.0023 | 0.0284 | Established |
| AR | −2.20 | 0.705 | 0.0700 | 0.0636 | Established |

TABLE 2-1

| | | | | Hot rolling | | | Cold | | | |
|---|---|---|---|---|---|---|---|---|---|---|
| | | | Heating | step | Coiling step | | rolling | | | |
| | | | step | Finish | Average | | step | | | |
| | | | Heating | rolling | cooling rate | | Cumulative | Annealing step | | |
| | | | temperature | finishing | up to coiling | Coiling | rolling | Heating | Holding | |
| | Com- | Classi- | of slab | temperature | temperature | temperature | reduction | temperature | time | Oxygen |
| No. | ponent | fication | [° C.] | [° C.] | [° C./s] | [° C.] | [%] | [° C.] | [sec] | potential |
| 1 | A | Example | 1317 | 950 | 36 | 467 | 2.1 | 803 | 93 | −0.50 |
| 2 | B | Example | 1343 | 931 | 87 | 461 | 4.6 | 853 | 503 | −1.22 |
| 3 | C | Example | 1255 | 946 | 82 | 417 | 1.7 | 858 | 59 | −0.20 |
| 4 | D | Example | 1228 | 922 | 52 | 243 | 2.0 | 837 | 329 | −0.18 |
| 5 | E | Example | 1319 | 924 | 45 | 384 | — | 835 | 596 | −1.32 |
| 6 | F | Example | 1302 | 927 | 28 | 472 | 3.1 | 861 | 596 | −0.28 |
| 7 | G | Example | 1326 | 947 | 48 | 470 | 1.3 | 876 | 240 | −0.81 |
| 8 | H | Example | 1284 | 929 | 21 | 437 | 1.9 | 885 | 600 | −0.18 |
| 9 | I | Example | 1283 | 949 | 39 | 466 | 9.7 | 899 | 362 | −1.08 |
| 10 | J | Example | 1220 | 941 | 74 | 430 | — | 844 | 12 | −0.17 |
| 11 | K | Example | 1288 | 935 | 70 | 474 | 16.0 | 888 | 409 | −0.17 |
| 12 | L | Example | 1293 | 923 | 60 | 306 | 3.0 | 850 | 334 | −1.20 |
| 13 | M | Example | 1348 | 911 | 90 | 442 | — | 889 | 374 | −0.11 |
| 14 | N | Example | 1288 | 943 | 67 | 193 | 2.5 | 869 | 93 | −0.31 |
| 15 | O | Example | 1328 | 933 | 97 | 182 | 15.9 | 882 | 575 | −0.14 |
| 16 | P | Example | 1261 | 918 | 45 | 432 | 2.7 | 803 | 240 | −0.37 |
| 17 | Q | Example | 1330 | 944 | 33 | 450 | 16.2 | 872 | 371 | −0.24 |
| 18 | R | Example | 1337 | 930 | 69 | 317 | 4.5 | 899 | 252 | −0.16 |
| 19 | S | Example | 1203 | 930 | 23 | 450 | 1.4 | 858 | 286 | −0.79 |
| 20 | T | Example | 1321 | 930 | 80 | 247 | 2.1 | 871 | 115 | −0.18 |
| 21 | U | Example | 1345 | 928 | 27 | 458 | 5.5 | 889 | 416 | −1.17 |
| 22 | V | Example | 1290 | 945 | 91 | 414 | 8.9 | 809 | 493 | −0.55 |
| 23 | W | Example | 1319 | 932 | 74 | 465 | 1.7 | 861 | 464 | −0.14 |
| 24 | X | Example | 1312 | 943 | 56 | 462 | 1.2 | 841 | 398 | −0.14 |
| 25 | Y | Example | 1325 | 938 | 67 | 462 | 15.6 | 885 | 182 | −0.19 |
| 26 | Z | Example | 1307 | 934 | 50 | 460 | 2.6 | 830 | 390 | −1.30 |
| 27 | AA | Example | 1321 | 934 | 98 | 163 | 12.9 | 898 | 213 | −0.14 |
| 28 | AB | Example | 1337 | 939 | 86 | 394 | — | 844 | 320 | −1.04 |
| 29 | AC | Example | 1337 | 940 | 61 | 203 | — | 821 | 599 | −0.18 |
| 30 | AD | Example | 1271 | 941 | 40 | 468 | 3.2 | 875 | 506 | −1.22 |
| 31 | AE | Comparative | 1297 | 922 | 40 | 181 | 2.4 | 879 | 239 | −0.12 |
| | | Example | | | | | | | | |
| 32 | AF | Comparative | 1199 | 937 | 65 | 449 | 2.1 | 870 | 581 | −0.32 |
| | | Example | | | | | | | | |
| 33 | AG | Comparative | 1343 | 942 | 21 | 460 | 2.6 | 880 | 470 | −0.23 |
| | | Example | | | | | | | | |
| 34 | AH | Comparative | 1247 | 950 | 98 | 469 | — | 866 | 307 | −1.04 |
| | | Example | | | | | | | | |
| 35 | AI | Comparative | 1325 | 919 | 90 | 408 | — | 816 | 327 | −0.23 |
| | | Example | | | | | | | | |
| 36 | AJ | Comparative | 1347 | 929 | 29 | 447 | 2.2 | 889 | 354 | −0.85 |
| | | Example | | | | | | | | |
| 37 | AK | Comparative | 1133 | 936 | 61 | 200 | — | 834 | 598 | −0.17 |
| | | Example | | | | | | | | |

TABLE 2-2

| | | | | Hot rolling | | | Cold | | | |
|---|---|---|---|---|---|---|---|---|---|---|
| | | | Heating | step | Coiling step | | rolling | | | |
| | | | step | Finish | Average | | step | | | |
| | | | Heating | rolling | cooling rate | | Cumulative | Annealing step | | |
| | | | temperature | finishing | up to coiling | Coiling | rolling | Heating | Holding | |
| | Com- | Classi- | of slab | temperature | temperature | temperature | reduction | temperaturc | time | Oxygen |
| No. | ponent | fication | [° C.] | [° C.] | [° C./s] | [° C.] | [%] | [° C.] | [sec] | potential |
| 38 | AL | Comparative | Testing not possible due to slab cracking | | | | | | | |
| | | Example | | | | | | | | |
| 39 | AM | Comparative | 1256 | 933 | 72 | 458 | 16.3 | 842 | 10 | −0.12 |
| | | Example | | | | | | | | |
| 40 | AN | Comparative | 1295 | 930 | 88 | 458 | 4.1 | 897 | 403 | −1.26 |
| | | Example | | | | | | | | |
| 41 | AO | Comparative | 1237 | 924 | 75 | 384 | 1.8 | 831 | 415 | −1.18 |
| | | Example | | | | | | | | |
| 42 | AP | Comparative | Testing not possible due to slab cracking | | | | | | | |
| | | Example | | | | | | | | |
| 43 | AQ | Comparative | 1275 | 946 | 34 | 315 | 2.6 | 855 | 106 | −0.51 |
| | | Example | | | | | | | | |
| 44 | AR | Comparative | 1385 | 932 | 55 | 465 | 15.2 | 892 | 588 | −1.23 |
| | | Example | | | | | | | | |
| 45 | A | Example | 1341 | 944 | 49 | 441 | — | 849 | 591 | −0.19 |
| 46 | B | Example | 1318 | 924 | 27 | 454 | 1.8 | 859 | 190 | −0.81 |
| 47 | C | Example | 1279 | 950 | 21 | 230 | 5.4 | 896 | 242 | −0.13 |
| 48 | D | Example | 1225 | 912 | 80 | 475 | — | 832 | 342 | −0.25 |
| 49 | E | Example | 1343 | 918 | 95 | 172 | 1.8 | 874 | 588 | −1.28 |
| 50 | F | Example | 1306 | 930 | 50 | 435 | 15.3 | 850 | 73 | −0.17 |
| 51 | G | Example | 1291 | 918 | 86 | 421 | 2.6 | 819 | 496 | −0.13 |
| 52 | H | Example | 1335 | 907 | 43 | 383 | 2.3 | 887 | 71 | −0.23 |
| 53 | I | Example | 1279 | 922 | 32 | 455 | 13.0 | 872 | 41 | −0.15 |
| 54 | J | Example | 1246 | 930 | 93 | 474 | 3.3 | 858 | 600 | −0.18 |
| 55 | K | Example | 1346 | 941 | 64 | 452 | 17.1 | 834 | 590 | −1.08 |
| 56 | L | Example | 1277 | 940 | 58 | 452 | 9.6 | 825 | 331 | −0.15 |
| 57 | M | Example | 1323 | 922 | 55 | 204 | — | 889 | 558 | −0.54 |
| 58 | N | Example | 1273 | 943 | 73 | 475 | 3.2 | 844 | 10 | −1.29 |
| 59 | O | Example | 1334 | 927 | 37 | 318 | 3.9 | 826 | 534 | −0.37 |
| 60 | P | Example | 1196 | 919 | 73 | 441 | 2.1 | 880 | 24 | −1.22 |
| 61 | Q | Comparative | 1202 | 930 | 43 | 472 | 3.6 | 873 | 577 | −1.31 |
| | | Example | | | | | | | | |
| 62 | S | Comparative | 1355 | 928 | 17 | 411 | 1.8 | 814 | 455 | −1.24 |
| | | Example | | | | | | | | |
| 63 | V | Comparative | 1345 | 915 | 95 | 512 | 3.7 | 820 | 242 | −0.09 |
| | | Example | | | | | | | | |
| 64 | X | Comparative | 1329 | 938 | 46 | 459 | 22.0 | 849 | 510 | −0.14 |
| | | Example | | | | | | | | |
| 65 | Y | Comparative | 1264 | 943 | 64 | 460 | — | 730 | 435 | −0.18 |
| | | Example | | | | | | | | |
| 66 | AA | Comparative | 1315 | 939 | 50 | 313 | 2.4 | 889 | 485 | −1.54 |
| | | Example | | | | | | | | |
| 67 | AC | Comparative | 1245 | 928 | 63 | 445 | — | 866 | 478 | −0.31 |
| | | Example | | | | | | | | |
| 68 | A | Comparative | 1334 | 930 | 54 | 193 | 2.1 | 827 | 72 | −0.93 |
| | | Example | | | | | | | | |
| 69 | B | Comparative | 1295 | 929 | 38 | 169 | 16.4 | 834 | 390 | −0.27 |
| | | Example | | | | | | | | |
| 70 | C | Comparative | 1279 | 931 | 82 | 470 | 13.9 | 879 | 600 | −0.24 |
| | | Example | | | | | | | | |
| 71 | D | Comparative | 1274 | 940 | 85 | 437 | 15.7 | 883 | 311 | −0.32 |
| | | Example | | | | | | | | |
| 72 | E | Comparative | 1284 | 936 | 29 | 204 | 1.9 | 846 | 591 | −0.14 |
| | | Example | | | | | | | | |
| 73 | L | Comparative | 1290 | 925 | 57 | 299 | 2.8 | 852 | 4 | −1.21 |
| | | Example | | | | | | | | |

TABLE 3-1

| | | | Holding | Second | | | |
|---|---|---|---|---|---|---|---|
| | | | step | cooling | | | |
| | First cooling step | | Holding time | step | | | |
| | Average | | in first | Average | | Remark | |
| | cooling | Cooling stop | temperature | cooling | | Ms | Bs |
| | rate | temperature | range | rate | | point | point |
| No. | [° C./s] | [° C.] | [s] | [° C./s] | Kind | [° C.] | [° C.] |
| 1 | 127 | 180 | 253 | 82 | Cold-rolled | 266 | 459 |
| | | | | | steel sheet | | |
| 2 | 135 | 279 | 122 | 32 | Cold-rolled | 366 | 551 |
| | | | | | steel sheet | | |
| 3 | 42 | 261 | 316 | 125 | Cold-rolled | 344 | 551 |
| | | | | | steel sheet | | |
| 4 | 83 | 244 | 197 | 106 | Cold-rolled | 324 | 484 |
| | | | | | steel sheet | | |
| 5 | 61 | 228 | 553 | 28 | Hot-rolled | 318 | 512 |
| | | | | | steel sheet | | |
| 6 | 134 | 236 | 510 | 31 | Hot-dip | 320 | 547 |
| | | | | | galvannealed | | |
| | | | | | steel sheet | | |
| 7 | 34 | 163 | 591 | 49 | Cold-rolled | 250 | 394 |
| | | | | | steel sheet | | |
| 8 | 36 | 243 | 479 | 30 | Hot-dip | 328 | 583 |
| | | | | | galvannealed | | |
| | | | | | steel sheet | | |
| 9 | 44 | 181 | 93 | 30 | Cold-rolled | 268 | 478 |
| | | | | | steel sheet | | |
| 10 | 125 | 227 | 356 | 120 | Hot-rolled | 312 | 493 |
| | | | | | steel sheet | | |
| 11 | 138 | 236 | 429 | 40 | Cold-rolled | 323 | 458 |
| | | | | | steel sheet | | |
| 12 | 46 | 180 | 306 | 54 | Hot-dip | 263 | 442 |
| | | | | | galvannealed | | |
| | | | | | steel sheet | | |
| 13 | 32 | 234 | 138 | 33 | Hot-rolled | 315 | 534 |
| | | | | | steel sheet | | |
| 14 | 111 | 287 | 391 | 32 | Hot-dip | 369 | 574 |
| | | | | | galvannealed | | |
| | | | | | steel sheet | | |
| 15 | 136 | 251 | 235 | 40 | Cold-rolled | 334 | 523 |
| | | | | | steel sheet | | |
| 16 | 45 | 216 | 551 | 29 | Cold-rolled | 299 | 452 |
| | | | | | steel sheet | | |
| 17 | 45 | 196 | 245 | 119 | Hot-dip | 280 | 463 |
| | | | | | galvannealed | | |
| | | | | | steel sheet | | |
| 18 | 113 | 162 | 187 | 29 | Hot-dip | 249 | 456 |
| | | | | | galvannealed | | |
| | | | | | steel sheet | | |
| 19 | 64 | 237 | 238 | 32 | Cold-rolled | 319 | 519 |
| | | | | | steel sheet | | |
| 20 | 136 | 267 | 90 | 37 | Hot-dip | 351 | 571 |
| | | | | | galvannealed | | |
| | | | | | steel sheet | | |
| 21 | 36 | 232 | 505 | 34 | Hot-dip | 321 | 462 |
| | | | | | galvannealed | | |
| | | | | | steel sheet | | |
| 22 | 38 | 158 | 351 | 126 | Hot-dip | 244 | 373 |
| | | | | | galvannealed | | |
| | | | | | steel sheet | | |
| 23 | 134 | 199 | 287 | 39 | Hot-dip | 287 | 479 |
| | | | | | galvannealed | | |
| | | | | | steel sheet | | |
| 24 | 132 | 165 | 138 | 35 | Hot-dip | 249 | 405 |
| | | | | | galvannealed | | |
| | | | | | steel sheet | | |
| 25 | 41 | 129 | 428 | 101 | Cold-rolled | 215 | 331 |
| | | | | | steel sheet | | |
| 26 | 131 | 165 | 107 | 59 | Hot-dip | 247 | 432 |
| | | | | | galvannealed | | |
| | | | | | steel sheet | | |
| 27 | 121 | 184 | 567 | 45 | Hot-dip | 269 | 488 |
| | | | | | galvannealed | | |
| | | | | | steel sheet | | |
| 28 | 82 | 201 | 471 | 36 | Hot-rolled | 289 | 418 |
| | | | | | steel sheet | | |
| 29 | 139 | 249 | 408 | 82 | Hot-rolled | 331 | 494 |
| | | | | | steel sheet | | |
| 30 | 31 | 252 | 318 | 28 | Hot-dip | 334 | 466 |
| | | | | | galvannealed | | |
| | | | | | steel sheet | | |
| 31 | 48 | 240 | 502 | 33 | Hot-dip | 326 | 434 |
| | | | | | galvannealed | | |
| | | | | | steel sheet | | |
| 32 | 140 | 173 | 81 | 39 | Cold-rolled | 258 | 474 |
| | | | | | steel sheet | | |
| 33 | 83 | 220 | 392 | 31 | Cold-rolled | 310 | 405 |
| | | | | | steel sheet | | |
| 34 | 34 | 172 | 345 | 50 | Hot-rolled | 259 | 393 |
| | | | | | steel sheet | | |
| 35 | 125 | 219 | 452 | 29 | Hot-rolled | 299 | 549 |
| | | | | | steel sheet | | |
| 36 | 46 | 235 | 272 | 37 | Hot-dip | 315 | 420 |
| | | | | | galvannealed | | |
| | | | | | steel sheet | | |
| 37 | 32 | 210 | 539 | 29 | Hot-rolled | 298 | 467 |
| | | | | | steel sheet | | |

TABLE 3-2

| | | | Holding | | | | |
|---|---|---|---|---|---|---|---|
| | | | step | Second | | | |
| | First cooling step | | Holding time | cooling | | | |
| | | Cooling | in first | step | | Remark | |
| | Average | stop | temperature | Average | | Ms | Bs |
| | cooling rate | temperature | range | cooling rate | | point | point |
| No. | [° C./s] | [° C.] | [s] | [° C./s] | Kind | [° C.] | [° C.] |
| 38 | Testing not possible due to slab cracking | | | | — | — | — |
| 39 | 58 | 148 | 279 | 116 | Cold-rolled | 235 | 389 |
| | | | | | steel sheet | | |
| 40 | 137 | 198 | 117 | 106 | Cold-rolled | 284 | 511 |
| | | | | | steel sheet | | |
| 41 | 33 | 227 | 189 | 61 | Cold-rolled | 309 | 483 |
| | | | | | steel sheet | | |
| 42 | Testing not possible due to slab cracking | | | | — | — | — |
| 43 | 39 | 120 | 140 | 79 | Cold-rolled | 203 | 319 |
| | | | | | steel sheet | | |
| 44 | 135 | 197 | 208 | 37 | Cold-rolled | 278 | 518 |
| | | | | | steel sheet | | |
| 45 | 132 | 182 | 463 | 125 | Hot-rolled | 266 | 459 |
| | | | | | steel sheet | | |
| 46 | 128 | 282 | 363 | 28 | Cold-rolled | 368 | 552 |
| | | | | | steel sheet | | |
| 47 | 30 | 262 | 68 | 30 | Hot-dip | 344 | 551 |
| | | | | | galvannealed | | |
| | | | | | steel sheet | | |
| 48 | 105 | 238 | 337 | 78 | Hot-rolled | 324 | 484 |
| | | | | | steel sheet | | |
| 49 | 124 | 232 | 118 | 123 | Hot-dip | 318 | 512 |
| | | | | | galvannealed | | |
| | | | | | steel sheet | | |
| 50 | 35 | 238 | 224 | 34 | Cold-rolled | 320 | 547 |
| | | | | | steel sheet | | |
| 51 | 133 | 171 | 495 | 33 | Hot-dip | 251 | 395 |
| | | | | | galvannealed | | |
| | | | | | steel sheet | | |
| 52 | 88 | 240 | 529 | 50 | Hot-dip | 328 | 583 |
| | | | | | galvannealed | | |
| | | | | | steel sheet | | |
| 53 | 134 | 179 | 142 | 34 | Hot-dip | 268 | 478 |
| | | | | | galvannealed | | |
| | | | | | steel sheet | | |
| 54 | 64 | 224 | 398 | 104 | Hot-dip | 312 | 493 |
| | | | | | galvannealed | | |
| | | | | | steel sheet | | |
| 55 | 36 | 237 | 198 | 37 | Cold-rolled | 324 | 459 |
| | | | | | steel sheet | | |
| 56 | 42 | 176 | 450 | 40 | Cold-rolled | 265 | 443 |
| | | | | | steel sheet | | |
| 57 | 140 | 226 | 486 | 57 | Hot-rolled | 315 | 534 |
| | | | | | steel sheet | | |
| 58 | 134 | 277 | 252 | 40 | Hot-dip | 367 | 573 |
| | | | | | galvanized | | |
| | | | | | steel sheet | | |
| 59 | 32 | 246 | 565 | 33 | Hot-dip | 334 | 523 |
| | | | | | galvanized | | |
| | | | | | steel sheet | | |
| 60 | 51 | 214 | 279 | 119 | Cold-rolled | 298 | 451 |
| | | | | | steel sheet | | |
| 61 | 141 | 193 | 142 | 30 | Cold-rolled | 280 | 463 |
| | | | | | steel sheet | | |
| 62 | 32 | 238 | 583 | 121 | Hot-dip | 319 | 519 |
| | | | | | galvanized | | |
| | | | | | steel sheet | | |
| 63 | 34 | 164 | 200 | 98 | Cold-rolled | 244 | 373 |
| | | | | | steel sheet | | |
| 64 | 126 | 169 | 228 | 32 | Cold-rolled | 249 | 405 |
| | | | | | steel sheet | | |
| 65 | 48 | 129 | 541 | 31 | Hot-rolled | 195 | 319 |
| | | | | | steel sheet | | |
| 66 | 110 | 179 | 123 | 38 | Hot-dip | 269 | 488 |
| | | | | | galvanized | | |
| | | | | | steel sheet | | |
| 67 | 17 | 250 | 353 | 39 | Hot-rolled | 324 | 490 |
| | | | | | steel sheet | | |
| 68 | 33 | 124 | 503 | 53 | Cold-rolled | 266 | 459 |
| | | | | | steel sheet | | |
| 69 | 134 | 561 | 313 | 33 | Hot-dip | 367 | 551 |
| | | | | | galvanized | | |
| | | | | | steel sheet | | |
| 70 | 136 | 258 | 44 | 79 | Hot-dip | 344 | 551 |
| | | | | | galvanized | | |
| | | | | | steel sheet | | |
| 71 | 79 | 240 | 617 | 42 | Cold-rolled | 324 | 484 |
| | | | | | steel sheet | | |
| 72 | 45 | 228 | 474 | 17 | Hot-dip | 318 | 512 |
| | | | | | galvanized | | |
| | | | | | steel sheet | | |
| 73 | 44 | 178 | 305 | 55 | Hot-dip | 263 | 442 |
| | | | | | galvanized | | |
| | | | | | steel sheet | | |

TABLE 4-1

| | | | | | | | Surface layer region Structure | | | | |
|---|---|---|---|---|---|---|---|---|---|---|---|
| | | | | | | | | | | | Prior |
| | | | | | | | | | | | austenite |
| | | | Base steel sheet t/4 position Structure | | | | | | | | diameter |
| | | | Tempered | Residual | | | | | Bainite + | | in sheet |
| | | | martensite | austenite | Ferrite | Remainder | Bainite | Ferrite | Ferrite | Remainder | thickness |
| | Com- | Classi- | fraction | fraction | fraction | fraction | fraction | fraction | total | fraction | direction |
| No. | ponent | fication | [%] | [%] | [%] | [%] | [%] | [%] | [%] | [%] | [μm] |
| 1 | A | Example | 91 | 8 | 0 | 1 | 34 | 7 | 41 | 66 | 7.9 |
| 2 | B | Example | 91 | 7 | 2 | 0 | 34 | 21 | 55 | 66 | 7.5 |
| 3 | C | Example | 87 | 9 | 0 | 4 | 31 | 9 | 40 | 69 | 7.0 |
| 4 | D | Example | 85 | 7 | 0 | 8 | 33 | 3 | 36 | 67 | 6.9 |
| 5 | E | Example | 91 | 7 | 2 | 0 | 35 | 24 | 59 | 65 | 7.2 |
| 6 | F | Example | 90 | 9 | 0 | 1 | 35 | 4 | 39 | 65 | 7.6 |
| 7 | G | Example | 90 | 8 | 1 | 1 | 35 | 18 | 53 | 65 | 6.3 |
| 8 | H | Example | 90 | 9 | 0 | 1 | 31 | 20 | 51 | 69 | 8.8 |
| 9 | I | Example | 91 | 7 | 0 | 2 | 31 | 9 | 40 | 69 | 7.6 |
| 10 | J | Example | 91 | 8 | 0 | 1 | 33 | 8 | 41 | 67 | 8.2 |
| 11 | K | Example | 89 | 7 | 1 | 3 | 35 | 25 | 60 | 65 | 8.5 |
| 12 | L | Example | 88 | 10 | 1 | 1 | 33 | 24 | 57 | 67 | 6.8 |
| 13 | M | Example | 87 | 12 | 0 | 1 | 33 | 7 | 40 | 67 | 6.6 |
| 14 | N | Example | 87 | 12 | 0 | 1 | 33 | 11 | 44 | 67 | 9.1 |
| 15 | O | Example | 87 | 10 | 0 | 3 | 31 | 25 | 56 | 69 | 9.1 |
| 16 | P | Example | 88 | 11 | 0 | 1 | 35 | 24 | 59 | 65 | 9.4 |
| 17 | Q | Example | 89 | 9 | 0 | 2 | 34 | 24 | 58 | 66 | 8.8 |
| 18 | R | Example | 89 | 10 | 0 | 1 | 33 | 8 | 41 | 67 | 7.6 |
| 19 | S | Example | 86 | 11 | 0 | 3 | 35 | 21 | 56 | 65 | 7.8 |
| 20 | T | Example | 88 | 10 | 1 | 1 | 32 | 24 | 56 | 68 | 6.9 |
| 21 | U | Example | 91 | 7 | 1 | 1 | 35 | 7 | 42 | 65 | 7.6 |
| 22 | V | Example | 90 | 8 | 1 | 1 | 34 | 6 | 40 | 66 | 7.5 |
| 23 | W | Example | 89 | 9 | 0 | 2 | 35 | 18 | 53 | 65 | 6.3 |
| 24 | X | Example | 89 | 7 | 0 | 4 | 32 | 8 | 40 | 68 | 8.0 |
| 25 | Y | Example | 90 | 9 | 0 | 1 | 34 | 21 | 55 | 66 | 9.6 |
| 26 | Z | Example | 87 | 8 | 0 | 5 | 31 | 23 | 54 | 69 | 6.5 |
| 27 | AA | Example | 87 | 12 | 0 | 1 | 33 | 10 | 43 | 67 | 8.6 |
| 28 | AB | Example | 91 | 7 | 0 | 2 | 33 | 18 | 51 | 67 | 9.7 |
| 29 | AC | Example | 85 | 13 | 0 | 2 | 31 | 23 | 54 | 69 | 6.4 |
| 30 | AD | Example | 85 | 12 | 0 | 3 | 35 | 17 | 52 | 65 | 8.7 |
| 31 | AE | Comparative | 90 | 9 | 0 | 1 | 35 | 19 | 54 | 65 | 6.8 |
| | | Example | | | | | | | | | |
| 32 | AF | Comparative | 91 | 8 | 0 | 1 | 35 | 19 | 54 | 65 | 8.6 |
| | | Example | | | | | | | | | |
| 33 | AG | Comparative | 91 | 3 | 2 | 4 | 33 | 26 | 59 | 67 | 7.5 |
| | | Example | | | | | | | | | |
| 34 | AH | Comparative | 91 | 7 | 0 | 2 | 35 | 4 | 39 | 65 | 8.9 |
| | | Example | | | | | | | | | |
| 35 | AI | Comparative | 65 | 11 | 0 | 24 | 45 | 0 | 45 | 55 | 9.8 |
| | | Example | | | | | | | | | |
| 36 | AJ | Comparative | 85 | 14 | 0 | 1 | 34 | 8 | 42 | 66 | 9.1 |
| | | Example | | | | | | | | | |
| 37 | AK | Comparative | 91 | 8 | 0 | 1 | 33 | 18 | 51 | 67 | 11.7 |
| | | Example | | | | | | | | | |

TABLE 4-2

| | | | | | | | Surface layer region Structure | | | | |
|---|---|---|---|---|---|---|---|---|---|---|---|
| | | | | | | | | | | | Prior |
| | | | | | | | | | | | austenite |
| | | | Base steel sheet t/4 position Structure | | | | | | | | diameter |
| | | | Tempered | Residual | | | | | Bainite + | | in sheet |
| | | | martensite | austenite | Ferrite | Remainder | Bainite | Ferrite | Ferrite | Remainder | thickness |
| | Com- | Classi- | fraction | fraction | fraction | fraction | fraction | fraction | total | fraction | direction |
| No. | ponent | fication | [%] | [%] | [%] | [%] | [%] | [%] | [%] | [%] | [μm] |
| 38 | AL | Comparative | Testing not possible due to slab cracking | | | | | | | | |
| | | Example | | | | | | | | | |
| 39 | AM | Comparative | 79 | 9 | 1 | 11 | 45 | 11 | 56 | 55 | 8.8 |
| | | Example | | | | | | | | | |
| 40 | AN | Comparative | 91 | 7 | 1 | 1 | 35 | 16 | 51 | 65 | 9.6 |
| | | Example | | | | | | | | | |
| 41 | AO | Comparative | 75 | 13 | 0 | 12 | 44 | 0 | 44 | 56 | 9.5 |
| | | Example | | | | | | | | | |
| 42 | AP | Comparative | Testing not possible due to slab cracking | | | | | | | | |
| | | Example | | | | | | | | | |
| 43 | AQ | Comparative | 87 | 10 | 0 | 3 | 33 | 7 | 40 | 67 | 11.3 |
| | | Example | | | | | | | | | |
| 44 | AR | Comparative | 86 | 13 | 0 | 1 | 32 | 7 | 39 | 68 | 9.1 |
| | | Example | | | | | | | | | |
| 45 | A | Example | 88 | 7 | 0 | 5 | 35 | 9 | 44 | 65 | 7.2 |
| 46 | B | Example | 91 | 7 | 0 | 2 | 35 | 8 | 43 | 65 | 9.8 |
| 47 | C | Example | 87 | 8 | 0 | 5 | 35 | 19 | 54 | 65 | 9.4 |
| 48 | D | Example | 90 | 8 | 0 | 2 | 35 | 22 | 57 | 65 | 6.5 |
| 49 | E | Example | 90 | 7 | 2 | 1 | 34 | 20 | 54 | 66 | 6.2 |
| 50 | F | Example | 87 | 12 | 0 | 1 | 31 | 10 | 41 | 69 | 9.2 |
| 51 | G | Example | 85 | 14 | 0 | 1 | 31 | 7 | 38 | 69 | 7.3 |
| 52 | H | Example | 89 | 9 | 0 | 2 | 34 | 20 | 54 | 66 | 7.8 |
| 53 | I | Example | 90 | 7 | 0 | 3 | 34 | 21 | 55 | 66 | 8.3 |
| 54 | J | Example | 91 | 8 | 0 | 1 | 35 | 6 | 41 | 65 | 6.8 |
| 55 | K | Example | 91 | 7 | 0 | 2 | 33 | 23 | 56 | 67 | 8.6 |
| 56 | L | Example | 90 | 8 | 0 | 2 | 35 | 6 | 41 | 65 | 8.8 |
| 57 | M | Example | 91 | 8 | 0 | 1 | 31 | 21 | 52 | 69 | 6.7 |
| 58 | N | Example | 91 | 7 | 2 | 0 | 35 | 21 | 56 | 65 | 9.4 |
| 59 | O | Example | 89 | 9 | 0 | 2 | 35 | 24 | 59 | 65 | 6.8 |
| 60 | P | Example | 89 | 8 | 1 | 2 | 31 | 10 | 41 | 69 | 8.2 |
| 61 | Q | Comparative | 91 | 7 | 0 | 2 | 34 | 22 | 56 | 66 | 10.8 |
| | | Example | | | | | | | | | |
| 62 | S | Comparative | 86 | 12 | 0 | 2 | 31 | 29 | 60 | 69 | 11.3 |
| | | Example | | | | | | | | | |
| 63 | V | Comparative | 85 | 12 | 1 | 2 | 35 | 16 | 51 | 65 | 10.6 |
| | | Example | | | | | | | | | |
| 64 | X | Comparative | 85 | 9 | 0 | 6 | 35 | 21 | 56 | 65 | 11.4 |
| | | Example | | | | | | | | | |
| 65 | Y | Comparative | 78 | 11 | 10 | 1 | 34 | 19 | 53 | 66 | 8.2 |
| | | Example | | | | | | | | | |
| 66 | AA | Comparative | 91 | 7 | 0 | 2 | 11 | 4 | 15 | 89 | 7.5 |
| | | Example | | | | | | | | | |
| 67 | AC | Comparative | 79 | 14 | 6 | 1 | 35 | 22 | 57 | 65 | 9.2 |
| | | Example | | | | | | | | | |
| 68 | A | Comparative | 100 | 0 | 0 | 0 | 31 | 28 | 59 | 69 | 6.8 |
| | | Example | | | | | | | | | |
| 69 | B | Comparative | 0 | 7 | 1 | 92 | 32 | 4 | 36 | 68 | 9.2 |
| | | Example | | | | | | | | | |
| 70 | C | Comparative | 88 | 5 | 0 | 7 | 32 | 9 | 41 | 68 | 8.7 |
| | | Example | | | | | | | | | |
| 71 | D | Comparative | 90 | 6 | 0 | 4 | 32 | 10 | 42 | 68 | 8.5 |
| | | Example | | | | | | | | | |
| 72 | E | Comparative | 91 | 5 | 2 | 2 | 34 | 21 | 55 | 66 | 8.1 |
| | | Example | | | | | | | | | |
| 73 | L | Example | 78 | 7 | 11 | 4 | 29 | 17 | 46 | 71 | 6.9 |

TABLE 5-1

Material

| | | | Presence or |
|---|---|---|---|
| | | | absence of |
| | | Bending | low- |
| | TS | angle | temperature |
| No. | [MPa] | [degree] | LME cracking |
| 1 | 1555 | 94 | Absent |
| 2 | 1589 | 92 | Absent |
| 3 | 1502 | 92 | Absent |
| 4 | 1479 | 92 | Absent |
| 5 | 1574 | 92 | Absent |
| 6 | 1519 | 90 | Absent |
| 7 | 1537 | 93 | Absent |
| 8 | 1529 | 90 | Absent |
| 9 | 1543 | 90 | Absent |
| 10 | 1544 | 91 | Absent |
| 11 | 1534 | 92 | Absent |
| 12 | 1537 | 94 | Absent |
| 13 | 1493 | 94 | Absent |
| 14 | 1517 | 90 | Absent |
| 15 | 1510 | 94 | Absent |
| 16 | 1493 | 93 | Absent |
| 17 | 1508 | 93 | Absent |
| 18 | 1524 | 94 | Absent |
| 19 | 1470 | 94 | Absent |
| 20 | 1517 | 92 | Absent |
| 21 | 1566 | 93 | Absent |
| 22 | 1530 | 94 | Absent |
| 23 | 1517 | 92 | Absent |
| 24 | 1523 | 93 | Absent |
| 25 | 1524 | 94 | Absent |
| 26 | 1509 | 92 | Absent |
| 27 | 1513 | 93 | Absent |
| 28 | 1542 | 94 | Absent |
| 29 | 1501 | 93 | Absent |
| 30 | 1495 | 94 | Absent |
| 31 | 1416 | 91 | Absent |
| 32 | 1534 | 94 | Present |
| 33 | 1557 | 74 | Absent |
| 34 | 1560 | 90 | Present |
| 35 | 1193 | 93 | Absent |
| 36 | 1478 | 94 | Present |
| 37 | 1543 | 94 | Present |

TABLE 5-2

Material

| | | | Presence or |
|---|---|---|---|
| | | | absence of |
| | | Bending | low- |
| | TS | angle | temperature |
| No. | [MPa] | [degree] | LME cracking |
| 38 | — | — | — |
| 39 | 1366 | 92 | Absent |
| 40 | 1538 | 94 | Present |
| 41 | 1318 | 92 | Absent |
| 42 | — | — | — |
| 43 | 1487 | 94 | Present |
| 44 | 1493 | 54 | Absent |
| 45 | 1508 | 92 | Absent |
| 46 | 1556 | 94 | Absent |
| 47 | 1489 | 94 | Absent |
| 48 | 1517 | 92 | Absent |
| 49 | 1570 | 94 | Absent |
| 50 | 1508 | 94 | Absent |
| 51 | 1474 | 94 | Absent |
| 52 | 1533 | 94 | Absent |
| 53 | 1554 | 94 | Absent |
| 54 | 1526 | 93 | Absent |
| 55 | 1533 | 93 | Absent |
| 56 | 1521 | 94 | Absent |
| 57 | 1551 | 94 | Absent |
| 58 | 1587 | 91 | Absent |
| 59 | 1523 | 93 | Absent |
| 60 | 1535 | 94 | Absent |
| 61 | 1530 | 94 | Present |
| 62 | 1483 | 90 | Present |
| 63 | 1471 | 94 | Present |
| 64 | 1470 | 92 | Present |
| 65 | 1380 | 93 | Absent |
| 66 | 1567 | 72 | Absent |
| 67 | 1360 | 90 | Absent |
| 68 | 1675 | 86 | Absent |
| 69 | 1352 | 94 | Absent |
| 70 | 1530 | 72 | Absent |
| 71 | 1440 | 73 | Absent |
| 72 | 1563 | 74 | Absent |
| 73 | 1437 | 98 | Absent |

As can be seen from Tables 1-1 to 5-2, in the invention examples, due to the preferable manufacturing conditions, the chemical composition, the metallographic structures at the t/4 position and in the surface layer region, and the diameter of the prior austenite grains in the sheet thickness direction were within the ranges of the present invention, and as a result, the invention examples had a strength as high as 1,470 MPa or more and were excellent in bendability and low-temperature LME resistance.

Contrary to this, in the comparative examples, one or more of the chemical composition, the metallographic structures at the t/4 position and in the surface layer region, and the diameter of the prior austenite grains in the sheet thickness direction deviated from the ranges of the present invention, and one or more of the tensile strength, the bendability, and the low-temperature LME resistance did not satisfy the targets.

### INDUSTRIAL APPLICABILITY

According to the present invention, it is possible to obtain a steel sheet having sufficient ductility, bendability, and LME resistance to be applicable to processing such as press forming, and a method of manufacturing the steel sheet. The present invention is capable of contributing to solving the global environmental issue by reducing the vehicle body weights of vehicles and significantly contributes to industrial development.

1. A steel sheet comprising:
a base steel sheet; and
a zinc-plated layer formed on a surface of the base steel sheet,
wherein the base steel sheet has a chemical composition including, by mass %,
C: 0.180% or more and 0.400% or less,
Si: 0.050% or more and 1.000% or less,
Mn: 2.00% or more and 4.00% or less,
Al: 0.10% or more and 2.00% or less,
Ti: 0.010% or more and 0.200% or less,
B: 0.0010% or more and 0.0100% or less,
N: 0.0010% or more and 0.0100% or less,
P: 0% or more and 0.0400% or less,
S: 0% or more and 0.0100% or less,
0: 0% or more and 0.0060% or less,
Cr: 0% or more and 0.50% or less,
Ni: 0% or more and 1.00% or less,
Cu: 0% or more and 1.00% or less,
Mo: 0% or more and 0.500% or less,
Nb: 0% or more and 0.200% or less,
V: 0% or more and 0.500% or less,
W: 0% or more and 0.100% or less,
Ta: 0% or more and 0.100% or less,
Sn: 0% or more and 0.050% or less,
Co: 0% or more and 0.500% or less,
As: 0% or more and 0.050% or less,
Sb: 0% or more and 0.050% or less,
Mg: 0% or more and 0.050% or less,
Ca: 0% or more and 0.040% or less,
REM: 0% or more and 0.050% or less,
Zr: 0% or more and 0.050% or less,
Bi: 0% or more and 0.050% or less,
Sr: 0% or more and 0.050% or less, and
a remainder: Fe and impurities,
when a sheet thickness of the base steel sheet is denoted by t, a metallographic structure at a t/4 position, which is a position at t/4 from the surface in a cross section in a sheet thickness direction of the base steel sheet, contains, by volume percentage,
tempered martensite: 85% or more,
residual austenite: 7% or more, and
one or more selected from ferrite, pearlite, bainite, and fresh martensite: 0% or more and 8% or less,
a metallographic structure in a surface layer region, which is a range from the surface to a position of 50 m in the cross section in the sheet thickness direction, contains, by volume percentage,
30% or more of bainite, and
remainder including one or more selected from ferrite, pearlite, tempered martensite, fresh martensite, and residual austenite,
in the surface layer region, a diameter of prior austenite grains in the sheet thickness direction is 10.0 m or less, and
a tensile strength of the steel sheet is 1,470 MPa or more.

2. The steel sheet according to claim 1,
wherein, when an Al content is denoted by <<Al>>, a N content is denoted by <<N>>, and a Ti content is denoted by <<Ti>> in terms of atomic %, Expression (1) is satisfied,
$$〈 〈 Al 〉 〉 \geq 〈 〈 N 〉 〉 - 0.5 \times 〈 〈 Ti 〉 〉 . \qquad ( 1 )$$

3. The steel sheet according to claim 1,
wherein the zinc-plated layer is a hot-dip galvanized layer.

4. The steel sheet according to claim 1,
wherein the zinc-plated layer is a hot-dip galvannealed layer.

5. A method of manufacturing a steel sheet, comprising:
a heating process of heating a slab such that a heating temperature T in units of K satisfies Expression (2) when an Al content is denoted by [Al] and a N content is denoted by [N] in terms of mass %;
a hot rolling process of hot-rolling the slab after the heating process to obtain a steel sheet;
a coiling process of cooling the steel sheet to a coiling temperature of 500° C. or lower at an average cooling rate of 20° C./sec or faster and coiling the steel sheet at the coiling temperature;
a cold rolling process of cold-rolling the steel sheet at a cumulative rolling reduction of 20% or less after pickling the steel sheet after the coiling process as necessary;
an annealing process of heating the steel sheet to an annealing temperature of an Ac3 point or higher and 900° C. or lower in an atmosphere having an oxygen potential of −1.50 or more and holding the steel sheet at the annealing temperature for 10 seconds or longer and 600 seconds or shorter;
a first cooling process of cooling the steel sheet after the annealing process to a first temperature range of an Ms point −100° C. or higher and a Bs point or lower at an average cooling rate of 20° C./sec or faster;
a holding process of holding the steel sheet in the first temperature range for 60 seconds or longer and 600 seconds or shorter; and
a second cooling process of cooling the steel sheet after the holding process to a second temperature range of 250° C. or lower and 150° C. or higher at an average cooling rate of 20° C./sec or faster,
$${log}_{10} ( [ Al ] \times [ N ] ) \leq - 9730 / T + 3.36 . \qquad ( 2 )$$

6. The steel sheet according to claim 2,
wherein the zinc-plated layer is a hot-dip galvanized layer.

7. The steel sheet according to claim 2,
wherein the zinc-plated layer is a hot-dip galvannealed layer.
